(19) United States
(12) Patent Application Publication
(10) Pub. No.: US 2024/0255622 A1
(43) Pub. Date: Aug. 1, 2024

(54) PHOTODETECTOR, PHOTODETECTION SYSTEM, AND PHOTODETECTION METHOD

(71) Applicant: SONY SEMICONDUCTOR SOLUTIONS CORPORATION, KANAGAWA (JP)

(72) Inventor: YUTAKA NAKADA, KANAGAWA (JP)

(21) Appl. No.: 18/560,970

(22) PCT Filed: Feb. 3, 2022
(86) PCT No.: PCT/JP2022/004257

§ 371 Date: Nov. 15, 2023

(30) Foreign Application Priority Data
Jun. 3, 2021 (JP) 2021-093715

(51) Int. Cl. G01S 7/4865; G01S 7/481; G01S 17/10

(52) U.S. Cl. CPC G01S 7/4865; G01S 7/4816; G01S 17/10

(57) ABSTRACT

It is desirable to provide a photodetector making it possible to prevent distance measuring accuracy from lowering even when interference light exists. A photodetector of the disclosure includes: a light-receiving element (PD) configured to detect light pulses having a predetermined pulse pattern; a histogram generation circuit (22) configured to generate a first histogram (H1) based on detection timings in the light-receiving element (PD); a filter circuit (23) configured to generate a second histogram (H2) based on the first histogram (H1) by filter processing using a filter coefficient pattern corresponding to the pulse pattern; and a representative value calculation circuit (24) configured to calculate a representative value of the detection timings based on the second histogram (H2). The filter circuit (23) is configured to exclude, from targets of the filter processing, a first frequency value being a maximum value (MAX) among a first plurality of frequency values in the first histogram (H1) or a processing-target histogram being an intermediate histogram corresponding thereto.

### TECHNICAL FIELD

The present disclosure relates to a photodetector, a photodetection system, and a photodetection method that detect light.

### BACKGROUND ART

To measure a distance to a measurement target, a time-of-flight (ToF) method is often used. In the ToF method, light is emitted, and reflected light reflected by the measurement target is detected. In the TOF method, a time difference between a timing of emitting light and a timing of detecting reflected light is then measured to measure a distance to the measurement target.

As to a radar machine, incidentally, in a case where there is a plurality of radar machines, interference may occur among the plurality of radar machines. PTL 1, for example, discloses a technique of attempting to prevent distance measuring accuracy from lowering due to interference among a plurality of radar machines.

### CITATION LIST

### Patent Literature

PTL 1: Japanese Unexamined Patent Application Publication No. 2002-14164

### SUMMARY OF THE INVENTION

It is desirable that, as described above, a photodetector be able to prevent its distance measuring accuracy from lowering even in a case where there is interference light.

It is desirable to provide a photodetector, a photodetection system, and a photodetection method that make it possible to prevent distance measuring accuracy from lowering even in a case where there is interference light.

A photodetector according to an embodiment of the present disclosure includes a light-receiving element, a histogram generation circuit, a filter circuit, and a representative value calculation circuit. The light-receiving element is configured to be able to detect a plurality of light pulses having a predetermined pulse pattern. The histogram generation circuit is configured to be able to generate a first histogram on the basis of detection timings in the light-receiving element. The filter circuit is able to generate a second histogram on the basis of the first histogram by performing filter processing using a filter coefficient pattern corresponding to the pulse pattern. The representative value calculation circuit is able to calculate a representative value of the detection timings on the basis of the second histogram. The filter circuit is able to exclude, from targets of the filter processing, a first frequency value being a maximum value among a first plurality of frequency values in the first histogram or a processing-target histogram being an intermediate histogram corresponding to the first histogram.

A photodetection system according to an embodiment of the present disclosure includes a light-emitting section, a light-receiving element, a histogram generation circuit, a filter circuit, and a representative value calculation circuit. The light-emitting section is configured to be able to emit a first plurality of light pulses having a predetermined pulse pattern. The light-receiving element is configured to be able to detect a second plurality of light pulses corresponding to the first plurality of light pulses. The histogram generation circuit is configured to be able to generate a first histogram on the basis of detection timings in the light-receiving element. The filter circuit is able to generate a second histogram on the basis of the first histogram by performing filter processing using a filter coefficient pattern corresponding to the pulse pattern. The representative value calculation circuit is able to calculate a representative value of the detection timings on the basis of the second histogram. The filter circuit is able to exclude, from targets of the filter processing, a first frequency value being a maximum value among a first plurality of frequency values in the first histogram or a processing-target histogram being an intermediate histogram corresponding to the first histogram.

A photodetection method according to an embodiment of the present disclosure includes: emitting a first plurality of light pulses having a predetermined pulse pattern; detecting a second plurality of light pulses corresponding to the first plurality of light pulses; generating a first histogram on a basis of detection timings of the second plurality of light pulses; generating a second histogram, on a basis of the first histogram, by performing filter processing using a filter coefficient pattern corresponding to the pulse pattern; excluding, from targets of the filter processing, a first frequency value being a maximum value among a first plurality of frequency values in the first histogram or a processing-target histogram being an intermediate histogram corresponding to the first histogram; and calculating a representative value of the detection timings on a basis of the second histogram.

In the photodetector, the photodetection system, and the photodetection method according to the embodiments of the present disclosure, the plurality of light pulses having a predetermined pulse pattern is detected, and the first histogram is generated on the basis of detection timings of the plurality of light pulses. As the filter processing is performed, on the basis of the first histogram, using a filter coefficient pattern corresponding to the pulse pattern, the second histogram is generated. At that time, the first frequency value being a maximum value among the first plurality of frequency values in the first histogram or the processing-target histogram being an intermediate histogram corresponding to the second histogram is excluded from targets of the filter processing. The representative value of the detection timings is then calculated on the basis of the second histogram.

### BRIEF DESCRIPTION OF DRAWING

FIG. 1 is a block diagram illustrating a configuration example of a photodetection system according to an embodiment of the present disclosure.

FIG. 2 is a waveform diagram illustrating an example of light pulses that a light-emitting section illustrated in FIG. 1 emits.

FIG. 3 is a circuit diagram illustrating a configuration example of a light-receiving section illustrated in FIG. 1.

FIG. 4 is a block diagram illustrating a configuration example of a histogram generation section illustrated in FIG. 1.

FIG. 5 is an explanatory diagram illustrating an operation example of the histogram generation section illustrated in FIG. 4.

FIG. 6 is a block diagram illustrating a configuration example of a filter processing section illustrated in FIG. 1.

FIG. 7 is an explanatory diagram illustrating an example of a filter coefficient pattern in the filter processing section illustrated in FIG. 6.

FIG. 8 is an explanatory diagram illustrating an example of the filter coefficient pattern.

FIG. 9 is an explanatory diagram illustrating an operation example of the filter processing.

FIG. 10A is another explanatory diagram illustrating the operation example of the filter processing.

FIG. 10B is still another explanatory diagram illustrating the operation example of the filter processing.

FIG. 10C is still another explanatory diagram illustrating the operation example of the filter processing.

FIG. 10D is still another explanatory diagram illustrating the operation example of the filter processing.

FIG. 10E is still another explanatory diagram illustrating the operation example of the filter processing.

FIG. 11 is an explanatory diagram illustrating an operation example of the photodetection system illustrated in FIG. 1.

FIG. 12 is a timing chart illustrating the operation example of the photodetection system illustrated in FIG. 1.

FIG. 13 is another timing chart illustrating the operation example of the photodetection system illustrated in FIG. 1.

FIG. 14 is still another timing chart illustrating the operation example of the photodetection system illustrated in FIG. 1.

FIG. 15 is an explanatory diagram illustrating an operation example of the filter processing section illustrated in FIG. 6.

FIG. 16A is an explanatory diagram illustrating the operation example of the filter processing section illustrated in FIG. 6.

FIG. 16B is another explanatory diagram illustrating the operation example of the filter processing section illustrated in FIG. 6.

FIG. 16C is still another explanatory diagram illustrating the operation example of the filter processing section illustrated in FIG. 6.

FIG. 16D is still another explanatory diagram illustrating the operation example of the filter processing section illustrated in FIG. 6.

FIG. 16E is still another explanatory diagram illustrating the operation example of the filter processing section illustrated in FIG. 6.

FIG. 17 is another explanatory diagram illustrating an operation example of a filter processing section according to a comparative example.

FIG. 18 is still another explanatory diagram illustrating the operation example of the filter processing section illustrated in FIG. 6.

FIG. 19 is still another explanatory diagram illustrating the operation example of the filter processing section illustrated in FIG. 6.

FIG. 20 is still another explanatory diagram illustrating the operation example of the filter processing section illustrated in FIG. 6.

FIG. 21 is still another explanatory diagram illustrating the operation example of the filter processing section illustrated in FIG. 6.

FIG. 22 is another explanatory diagram illustrating the operation example of the photodetection system illustrated in FIG. 1.

FIG. 23 is a block diagram illustrating a configuration example of a filter processing section according to a modification example.

FIG. 24 is a block diagram illustrating a configuration example of a filter processing section according to another modification example.

FIG. 25 is a block diagram illustrating a configuration example of a filter processing section according to still another modification example.

FIG. 26 is an explanatory diagram illustrating an operation example of the filter processing section illustrated in FIG. 25.

FIG. 27 is a block diagram illustrating a configuration example of a filter processing section according to still another modification example.

FIG. 28 is an explanatory diagram illustrating an operation example of the filter processing section illustrated in FIG. 27.

FIG. 29 is a block diagram illustrating a configuration example of a filter processing section according to still another modification example.

FIG. 30A is an explanatory diagram illustrating an operation example of the filter processing section illustrated in FIG. 29.

FIG. 30B is another explanatory diagram illustrating the operation example of the filter processing section illustrated in FIG. 29.

FIG. 30C is still another explanatory diagram illustrating the operation example of the filter processing section illustrated in FIG. 29.

FIG. 30D is still another explanatory diagram illustrating the operation example of the filter processing section illustrated in FIG. 29.

FIG. 31 is a block diagram illustrating a configuration example of a filter processing section according to still another modification example.

FIG. 32 is an explanatory diagram illustrating an operation example of the filter processing section illustrated in FIG. 31.

FIG. 33 is another explanatory diagram illustrating the operation example of the filter processing section illustrated in FIG. 31.

FIG. 34 is a timing chart illustrating an operation example of a photodetection system according to another modification example.

FIG. 35 is a block diagram illustrating a configuration example of a histogram generation section according to the other modification example.

FIG. 36 is a timing chart illustrating an operation example of a photodetection system including the histogram generation section illustrated in FIG. 35.

FIG. 37 is a block diagram depicting an example of schematic configuration of a vehicle control system.

FIG. 38 is a diagram of assistance in explaining an example of installation positions of an outside-vehicle information detecting section and an imaging section.

### MODES FOR CARRYING OUT THE INVENTION

In the following, an embodiment of the present disclosure will be described in detail with reference to the drawings. It is to be noted that the description will be given in the following order.

### 1. Embodiment

### 2. Example of Application to Mobile Body

### 1. Embodiment

### Configuration Example

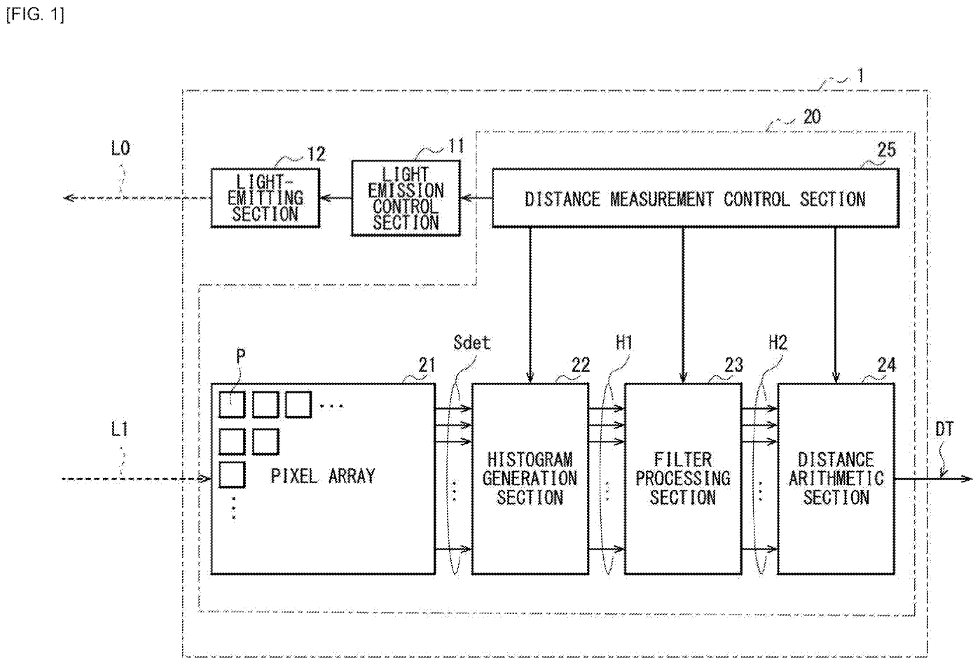

FIG. 1 illustrates a configuration example of a photodetection system according to an embodiment (a photodetection system 1). The photodetection system 1 is a ToF sensor and is configured to emit light, and to detect reflected light reflected by the measurement target. Note that a photodetector and a photodetection method according to the embodiment of the present disclosure are embodied through the description of the present embodiment, and are also described in here. The photodetection system 1 includes a photodetection unit 20, a light emission control section 11, and a light-emitting section 12.

The photodetection unit 20 is configured to provide an instruction to the light emission control section 11 to cause the light-emitting section 12 to emit light pulses L0 to detect light pulses reflected by a measurement target (reflected light pulses L1).

The light emission control section 11 is configured to control operation of the light-emitting section 12 on the basis of an instruction from the photodetection unit 20.

The light-emitting section 12 is configured to emit, on the basis of an instruction from the light emission control section 11, a plurality of light pulses L0 having a predetermined pulse pattern toward the measurement target. The light-emitting section 12 includes a light source that emits infrared light, for example. The light source includes a laser light source or light emitting diodes (LEDs), for example.

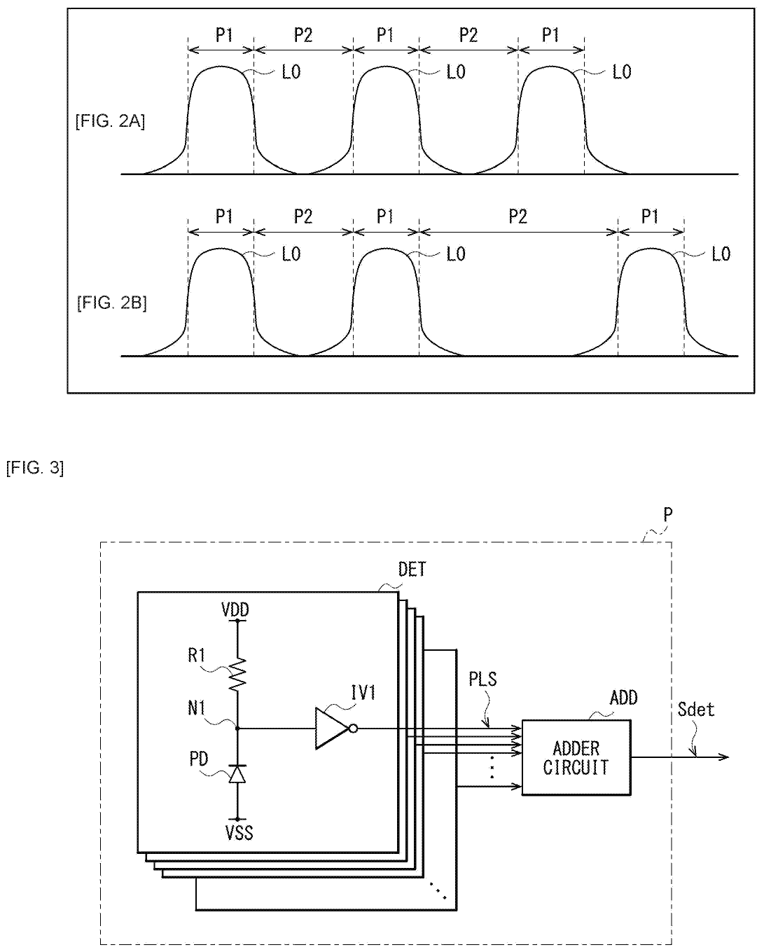

FIG. 2 illustrates types of emission light that the light-emitting section 12 emits, where (A) indicates an example of the emission light, and (B) indicates another example of the emission light. In this example, the light-emitting section 12 emits three light pulses L0. It is possible to set a pulse width P1 of one light pulse L0 to 4 nsec, for example. In the example illustrated in (A) in FIG. 2, two pulse intervals P2 among the three light pulses L0 are set to be equal to each other. In the example illustrated in (B) in FIG. 2, two pulse intervals P2 among three light pulses L0 are set to be different from each other. The plurality of light pulses L0 that the light-emitting section 12 emits has a pulse pattern, as described above. A pulse pattern is set by a distance measurement control section 25. A pulse pattern in the photodetection system 1 is set to be different from a pulse pattern in another photodetection system, for example. The light-emitting section 12 emits a plurality of light pulses L0 having such a pulse pattern as described above in each of a plurality of photodetection periods T that is repeatedly set, as will be described later.

The light pulses L0 emitted from the photodetection system 1 are reflected by a measurement target. The light pulses reflected by the measurement target (reflected light pulses L1) then enter the photodetection unit 20 in the photodetection system 1. The photodetection unit 20 detects the reflected light pulses L1.

The photodetection unit 20 includes a pixel array 21, a histogram generation section 22, a filter processing section 23, a distance arithmetic section 24, and the distance measurement control section 25.

The pixel array 21 includes a plurality of light-receiving sections P disposed in a matrix. Each of the plurality of light-receiving sections P is configured to detect light.

FIG. 3 illustrates a configuration example of each of the light-receiving sections P. The light-receiving section P includes a plurality of light-receiving circuits DET and an adder circuit ADD.

The plurality of light-receiving circuits DET each includes a photodiode PD, a resistance element R1, and an inverter IV1. The photodiode PD is a photoelectric conversion element that converts light into electrical charges. An anode of the photodiode PD is supplied with a power supply voltage VSS, and a cathode is coupled to a node N1. As the photodiode PD, it is possible to use a single photon avalanche diode (SPAD), for example. One end of the resistance element R1 is supplied with a power supply voltage VDD, and another end is coupled to the node N1. An input terminal of the inverter IV1 is coupled to the node N1, and an output terminal is coupled to an input terminal of the adder circuit ADD. The inverter IV1 is configured to output a low level in a case where a voltage at the node N1 is higher than a logical threshold value, and to output a high level in a case where the voltage at the node N1 is lower than the logical threshold value to generate a pulse signal PLS.

In the light-receiving circuit DET with this configuration, the photodiode PD detects light, whereby avalanche amplification occurs, and the voltage at the node N1 decreases. When the voltage at the node N1 falls below the logical threshold value of the inverter IV1, the pulse signal PLS then changes from the low level to the high level. Thereafter, as an electric current flows into the node N1 via the resistance element R1, the voltage at the node N1 increases. When the voltage at the node N1 exceeds the logical threshold value of the inverter IV1, the pulse signal PLS then changes from the high level to the low level. In this way, the light-receiving circuit DET generates a pulse signal PLS having a pulse corresponding to light detected.

The adder circuit ADD is configured to generate, on the basis of a plurality of pulse signals PLS supplied from the plurality of light-receiving circuits DET, a detection signal Sdet including a code indicating the number of pulses in the plurality of pulse signals PLS. Specifically, the adder circuit ADD generates a code indicating the number of the pulse signals PLS that are at the high level among the plurality of pulse signals PLS. In a case where the light-receiving section P includes nine light-receiving circuits DET, for example, the code indicates a value equal to or above 0 and equal to or below 9. In this case, the code is a four-bit code. The adder circuit ADD then supplies the detection signal Sdet including such a code as described above to the histogram generation section 22.

The histogram generation section 22 (FIG. 1) is configured to generate, on the basis of a detection signal Sdet, a histogram H1 about detection timings of the reflected light pulses L1 in each of the light-receiving sections P. The histogram generation section 22 generates each of a plurality of histograms H1 on the basis of each of the plurality of detection signals Sdet.

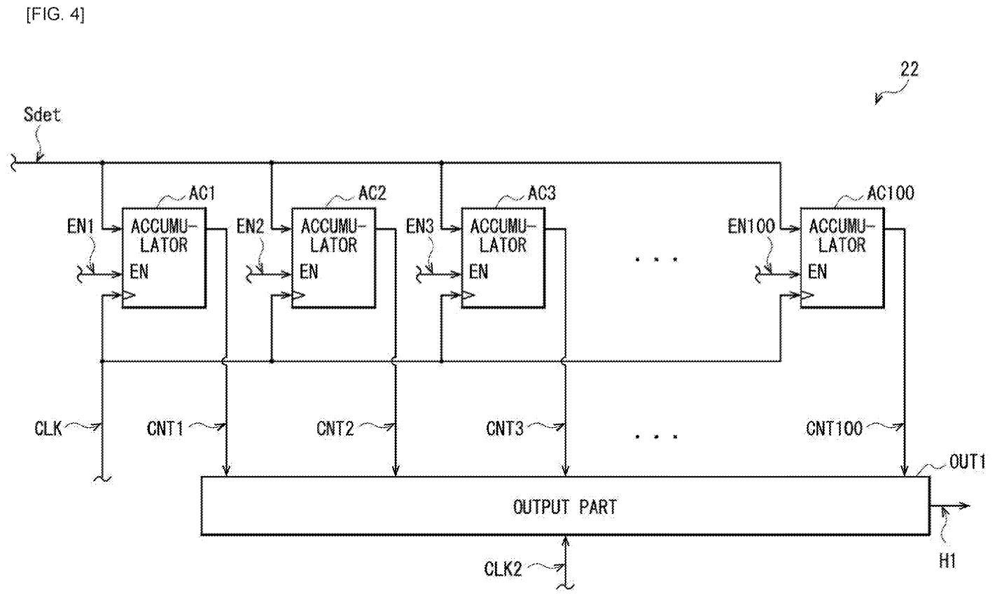

FIG. 4 illustrates a configuration example of a circuit that generates one histogram H1 on the basis of one detection signal Sdet in the histogram generation section 22. The histogram generation section 22 includes a plurality of accumulators AC (in this example, 100 accumulators AC1 to AC100) and an output part OUT1.

The accumulator AC1 is configured to cumulatively add, on the basis of a control signal EN1 and a clock signal CLK supplied from the distance measurement control section 25, a value of a code indicated by a detection signal Sdet within a period where the control signal EN1 becomes active to generate a count value CNT1. The control signal EN1 is a signal that becomes active within a period starting from a start timing of each of a plurality of photodetection periods T (described later) to have a time width of 1 nsec, for example. The clock signal CLK is a signal having a frequency of 1 GHz, for example. The accumulator AC1 latches the value of the code indicated by the detection signal Sdet within the period where the control signal EN1 becomes active in each of the plurality of photodetection periods T, cumulatively adds the latched value, and updates the count value CNT1.

Similarly, the accumulator AC2 is configured to cumulatively add, on the basis of a control signal EN2 and the clock signal CLK supplied from the distance measurement control section 25, the value of the code indicated by the detection signal Sdet within a period where the control signal EN2 becomes active to generate a count value CNT2. The control signal EN2 is a signal that becomes active within a period starting from a timing after 1 nsec has passed from the start timing of each of the plurality of photodetection periods T to have a time width of 1 nsec, for example. The accumulator AC2 latches the value of the code indicated by the detection signal Sdet within the period where the control signal EN2 becomes active in each of the plurality of photodetection periods T, cumulatively adds the latched value, and updates the count value CNT2.

The accumulator AC3 is configured to cumulatively add, on the basis of a control signal EN3 and the clock signal CLK supplied from the distance measurement control section 25, the value of the code indicated by the detection signal Sdet within a period where the control signal EN3 becomes active to generate a count value CNT3. The control signal EN3 is a signal that becomes active within a period starting from a timing after 2 nsec have passed from the start timing of each of the plurality of photodetection periods T to have a time width of 1 nsec, for example. The accumulator AC3 latches the value of the code indicated by the detection signal Sdet within the period where the control signal EN3 becomes active in each of the plurality of photodetection periods T, cumulatively adds the latched value, and updates the count value CNT3.

Although the accumulators AC1 to AC3 are selected and described as examples, the accumulators AC4 to AC100 operate in a similar manner.

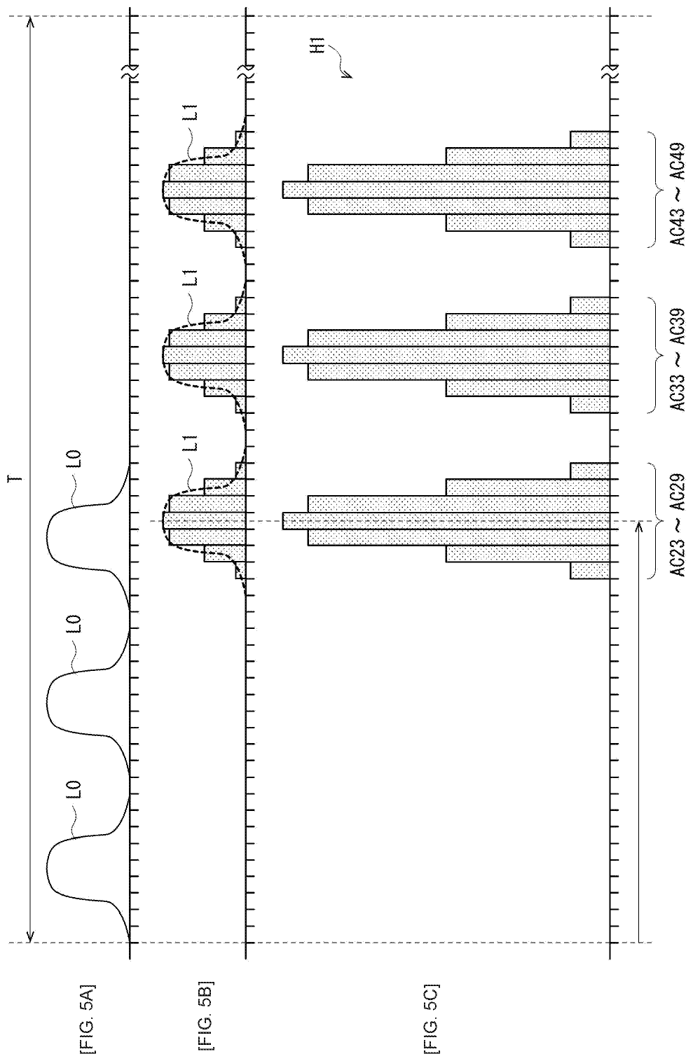

FIG. 5 illustrates an operation example of the accumulators AC1 to AC100 in the histogram generation section 22, where (A) indicates a waveform of light emitted by the light-emitting section 12, (B) indicates an example of count values CNT1 to CNT100 acquired in a first photodetection period T, and (C) indicates an example of the count values CNT1 to CNT100 acquired in a plurality of the photodetection periods T.

In the photodetection system 1, the light-emitting section 12 emits three light pulses L0 in each of a plurality of photodetection periods T that is repeatedly set ((A) in FIG. 5). A plurality of reflected light pulses L1 in accordance with the plurality of light pulses L0 then enters each of the light-receiving sections P ((B) in FIG. 5). The light-receiving sections P each receive reflected light pulses L1 to each generate a detection signal Sdet. The accumulators AC1 to AC100 in the histogram generation section 22 respectively generate count values CNT1 to CNT100 on the basis of the detection signal Sdet.

In this example, as illustrated in (B) in FIG. 5, the accumulators AC23 to AC29 respectively generate count values CNT23 to CNT29 in accordance with the first reflected light pulse L1 among the three reflected light pulses L1 in the first photodetection period T, the accumulators AC33 to AC39 respectively generate count values CNT33 to CNT39 in accordance with the second reflected light pulse L1, and the accumulators AC43 to AC49 respectively generate count values CNT43 to CNT49 in accordance with the third reflected light pulse L1. The accumulators AC1 to AC100 respectively cumulatively add the count values CNT1 to CNT100 in each of the plurality of photodetection periods T. Thereby, the accumulators AC1 to AC100 respectively generate the count values CNT1 to CNT100 as illustrated in (C) in FIG. 5. The count values CNT1 to CNT100 form a histogram H1. The count values CNT1 to CNT100 respectively are frequency values in the histogram H1. For example, a position of a peak among a range of distribution of the count values CNT23 to CNT29 in accordance with the first reflected light pulse L1 in the histogram H1 is a position in accordance with a distance between the photodetection system 1 and the measurement target.

In this way, the accumulators AC1 to AC100 respectively cumulatively add the count values CNT1 to CNT100 in each of the plurality of photodetection periods T. After the plurality of photodetection periods T has ended, the accumulators AC1 to AC100 then respectively supply the cumulatively added count values CNT1 to CNT100 to the output part OUT1.

The output part OUT1 (FIG. 4) sequentially outputs the count values CNT1 to CNT100, starting from the count value CNT1, on the basis of a clock signal CLK2, to supply the histogram H1 to the filter processing section 23.

In this way, the histogram generation section 22 generates one histogram H1 on the basis of one detection signal Sdet. The histogram generation section 22 performs such processing as described above on the basis of each of the plurality of detection signals Sdet to generate a plurality of histograms H1. The histogram generation section 22 then supplies the histograms H1 to the filter processing section 23.

The filter processing section 23 (FIG. 1) is configured to perform filter processing on each of the plurality of histograms H1 to generate each of a plurality of histograms H2.

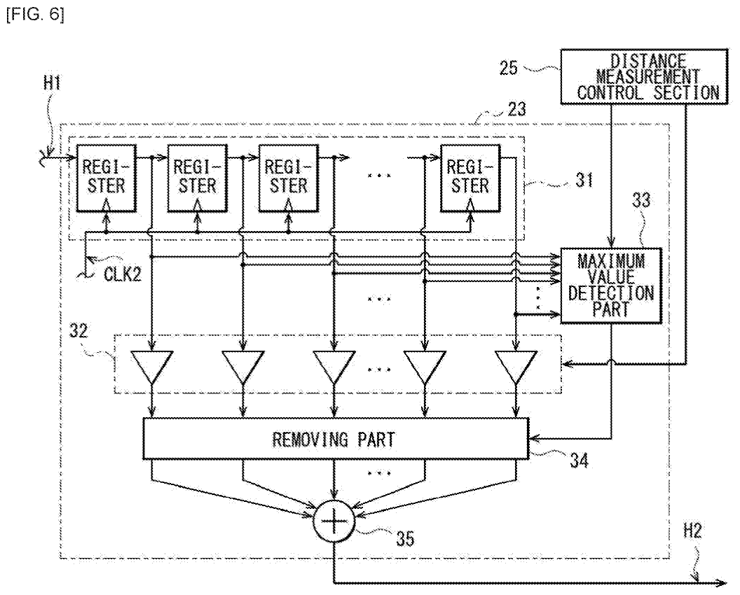

FIG. 6 illustrates a configuration example of a circuit that generates one histogram H2 on the basis of one histogram H1 in the filter processing section 23. The filter processing section 23 includes a shift register 31, a multiplying part 32, a maximum value detection part 33, a removing part 34, and an adding part 35.

The shift register 31 includes a plurality of registers. Each of the plurality of registers is configured to be able to store a count value including a plurality of bits. An input terminal of the register at a first stage is sequentially supplied with the count values CNT1 to CNT100 in the histogram H1 one by one, starting from the count value CNT1, and an output terminal is coupled to an input terminal of the register at a second stage. The input terminal of the register at the second stage is coupled to the output terminal of the register at the first stage, and an output terminal is coupled to an input terminal of the register at a third stage. The other registers are also similarly provided. In the shift register 31 with this configuration, a supplied count value is shifted one by one from the register at the first stage to the register at a final stage on the basis of a clock signal CLK2.

The multiplying part 32 respectively multiplies a plurality of output values of the plurality of registers included in the shift register 31 by a plurality of filter coefficients supplied from the distance measurement control section 25, and supplies a plurality of values acquired through the multiplications to the removing part 34.

The maximum value detection part 33 is configured to detect, on the basis of an instruction from the distance measurement control section 25, a maximum value among two or more output values among the plurality of output values outputted from the shift register 31. The maximum value detection part 33 then provides, to the removing part 34, an instruction of removing a value corresponding to the maximum value among a plurality of values outputted by the multiplying part 32.

The removing part 34 is configured to replace, on the basis of an instruction from the maximum value detection part 33, the value corresponding to the maximum value detected by the maximum value detection part 33 among the plurality of values supplied from the multiplying part 32 with “0”, and to output the replaced value, while outputting the others of the plurality of values as is. Thereby, in the filter processing section 23, the maximum value detected by the maximum value detection part 33 is excluded from targets that are subject to the filter processing.

The adding part 35 is configured to add the plurality of values outputted from the removing part 34 to each other.

The filter processing section 23 is supplied with the count values CNT1 to CNT100 in the histogram H1 one by one, starting from the count value CNT1. The shift register 31 causes the supplied count values to shift one by one from the register at the first stage to the register at the final stage. In the filter processing section 23, each time one of the count values CNT1 to CNT100 is supplied, the multiplying part 32 respectively multiplies output values of the plurality of registers included in the shift register 31 by a plurality of filter coefficients, the maximum value detection part 33 detects a maximum value from among two or more output values, the removing part 34 replaces a value corresponding to the maximum value detected by the maximum value detection part 33 among a plurality of values supplied from the multiplying part 32 with “0” and outputs the replaced value, and the adding part 35 adds the plurality of values outputted from the removing part 34 to each other.

The filter processing in the filter processing section 23 will now be described herein in detail. In the below description, operation of the maximum value detection part 33 and the removing part 34 will be omitted for purposes of description. Note that the operation of the maximum value detection part 33 and the removing part 34 will be described later in detail.

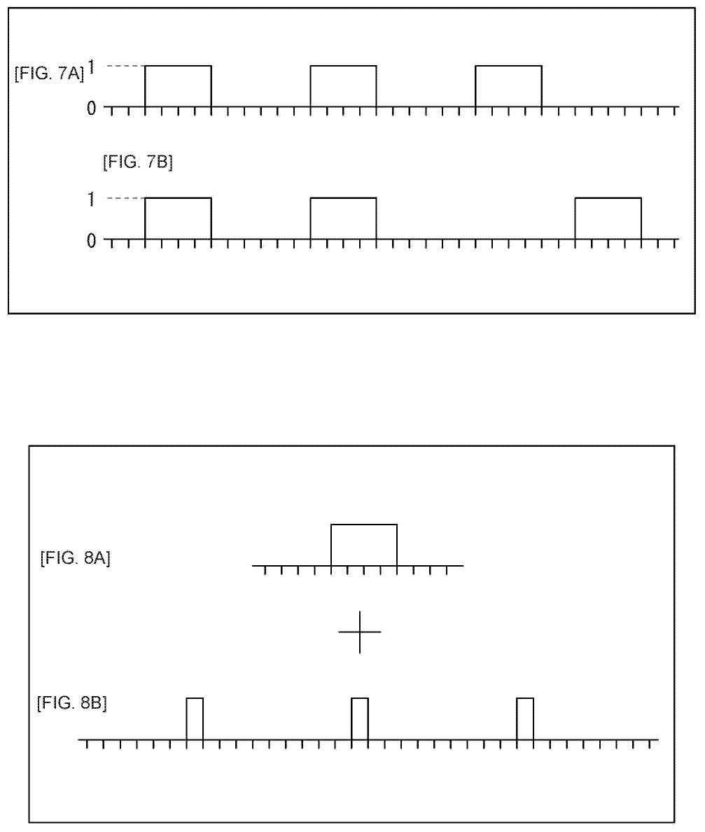

FIG. 7 illustrates a filter coefficient pattern including a plurality of filter coefficients, where (A) indicates an example of the filter coefficient pattern, and (B) indicates another example of the filter coefficient pattern. In this example, each of the plurality of filter coefficients is to be set to “0” or “1”. The filter coefficient pattern is set to correspond to each of pulse patterns of a plurality of light pulses L0 that the light-emitting section 12 emits. For example, the filter coefficient pattern illustrated in (A) in FIG. 7 corresponds to the pulse pattern illustrated in (A) in FIG. 2, and the filter coefficient pattern illustrated in (B) in FIG. 7 corresponds to the pulse pattern illustrated in (B) in FIG. 2. It is desirable that a width of a portion where the filter coefficient is “1” be set to 4 nsec in accordance with the pulse width of the light pulses L0.

FIG. 8 illustrates two filter coefficient patterns forming the filter coefficient pattern illustrated in (A) in FIG. 7. As illustrated in FIG. 8, it is possible to represent the filter coefficient pattern illustrated in (A) in FIG. 7 as a linear combination of the two filter coefficient patterns.

Filter processing using the filter coefficient pattern illustrated in (A) in FIG. 8 is called histogram filter processing. The filter coefficient pattern is set to correspond to a shape of light pulses L0. In a case where a shape of light pulses L0 has Gaussian distribution, for example, it is desirable that the filter coefficient pattern also have the Gaussian distribution.

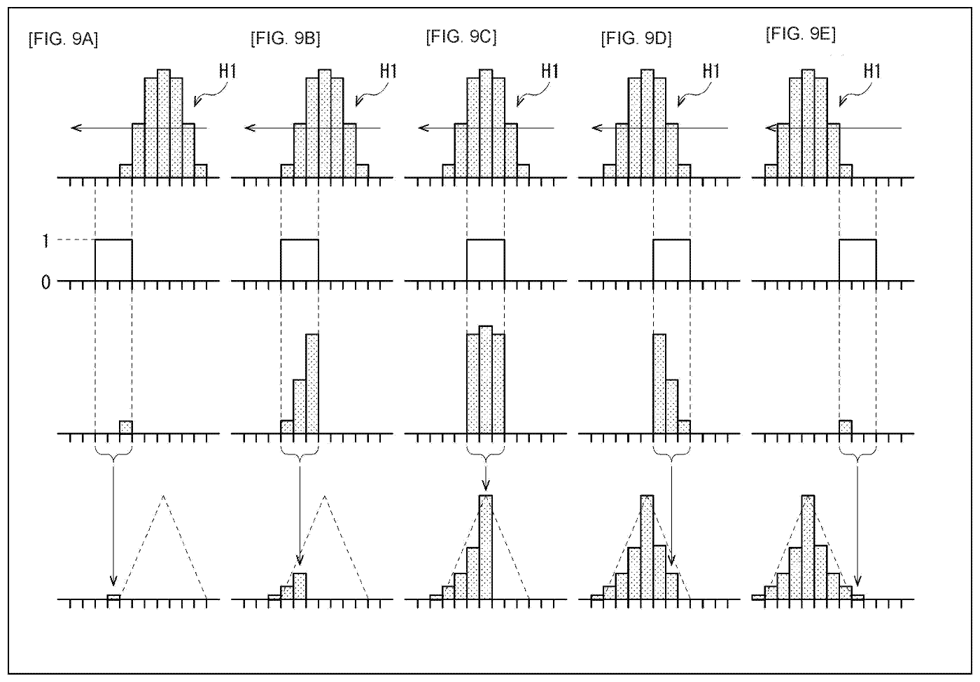

FIG. 9 illustrates an example of filter processing using the filter coefficient pattern illustrated in (A) in FIG. 8, where a top illustrates a histogram H1, a second stage from the top illustrates the filter coefficient pattern, a third stage from the top illustrates a result of multiplying a frequency value (a count value) in the histogram H1 by a filter coefficient of the filter coefficient pattern, and a fourth stage from the top illustrates a result of the filter processing. Note that, in this example, a width of a portion where the filter coefficient is “1” is set to 3 nsec for purposes of description.

As indicated by arrows, the histogram H1 moves from a right side of the filter coefficient pattern toward left one by one on a scale. As the histogram H1 moves, as illustrated in (A) to (E) in FIG. 9, a portion in the histogram H1, which is overlapping with a range where the filter coefficient is “1”, changes. Thereby, such a histogram as illustrated at a bottom stage is generated. In a shape of the generated histogram, a peak becomes further prominent, compared with a shape of the histogram H1. As described above, performing the histogram filter processing makes it possible to change the shape of a histogram.

The filter processing using the filter coefficient pattern illustrated in (B) in FIG. 8 is called decoding filter processing. That is, the filter coefficient pattern corresponds to a pulse pattern of a plurality of light pulses L0 (in this example, (A) in FIG. 2). Thereby, matching of a pattern of the histogram H1 and the filter coefficient pattern with each other is thus attained in a case where the photodetection system 1 has detected a plurality of reflected light pulses L1 in accordance with a plurality of light pulses L0 that the photodetection system 1 itself has emitted, making it possible to generate a histogram H2 having a further higher peak, as described below.

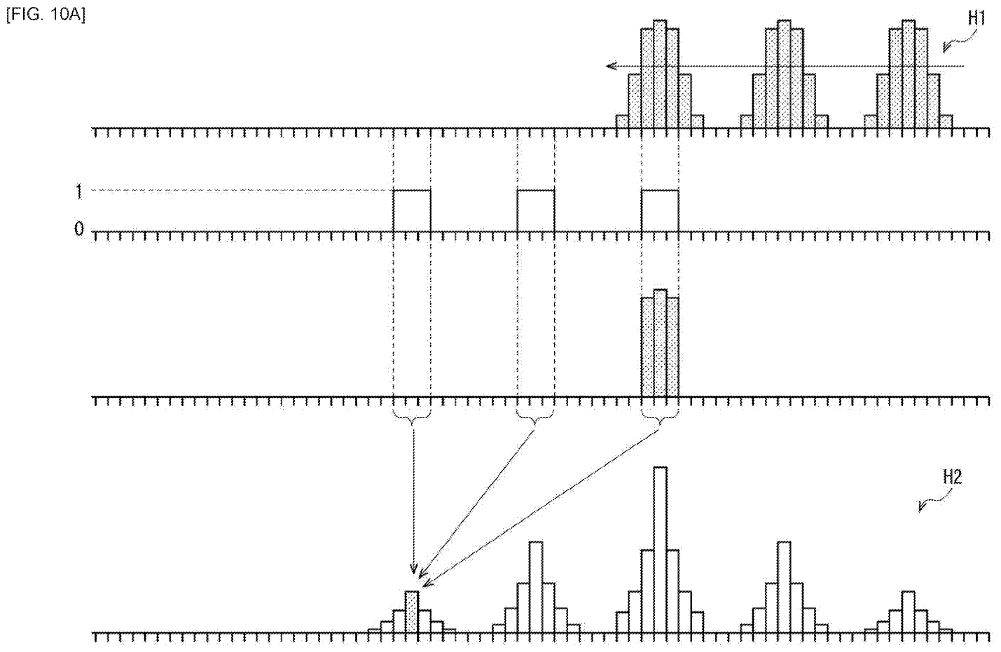

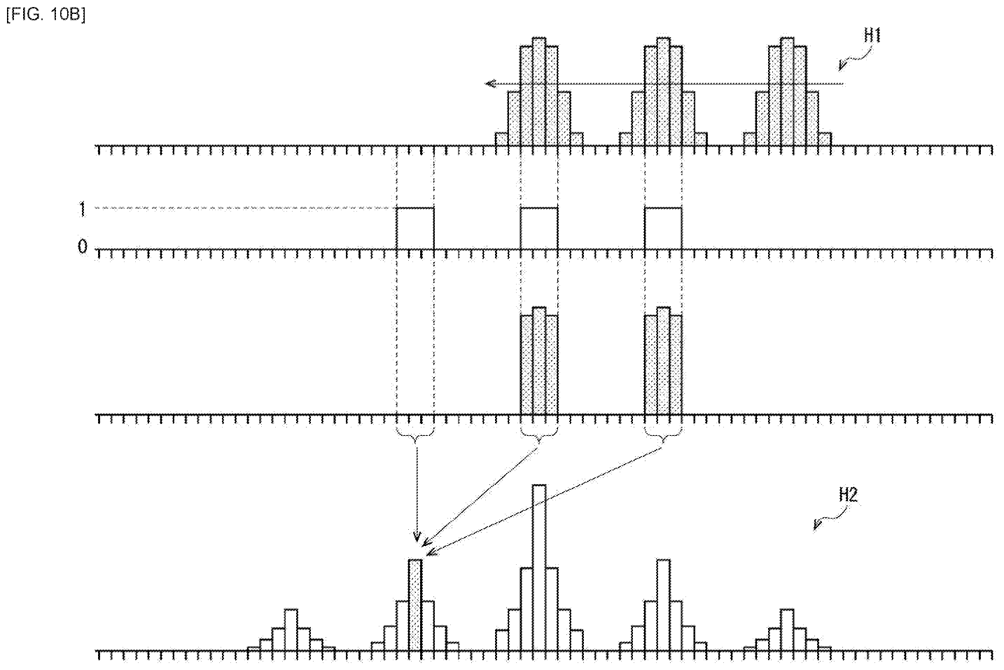

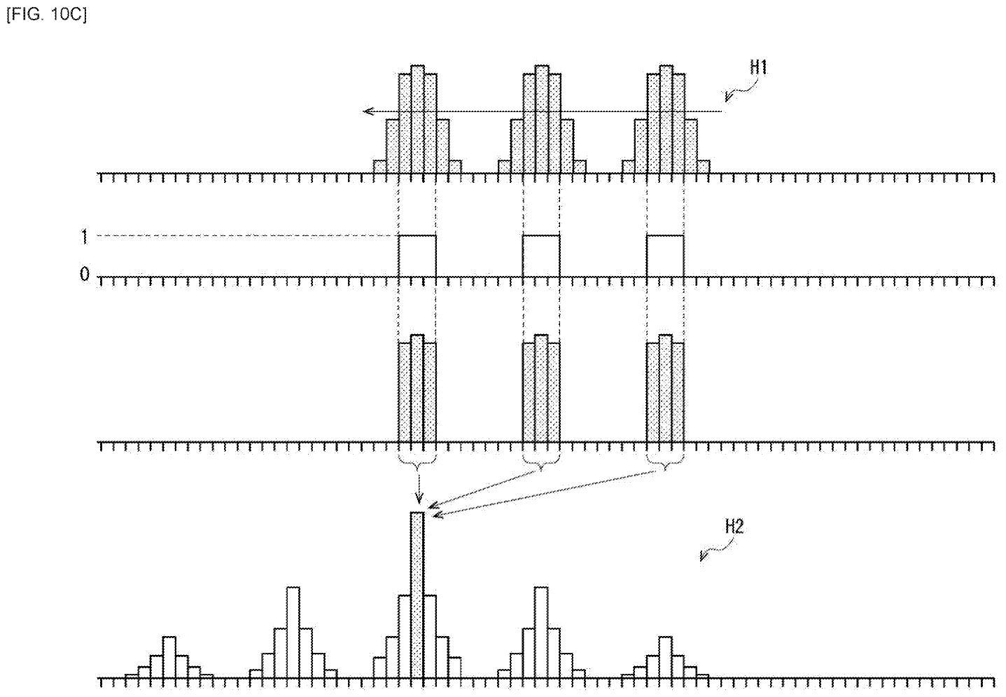

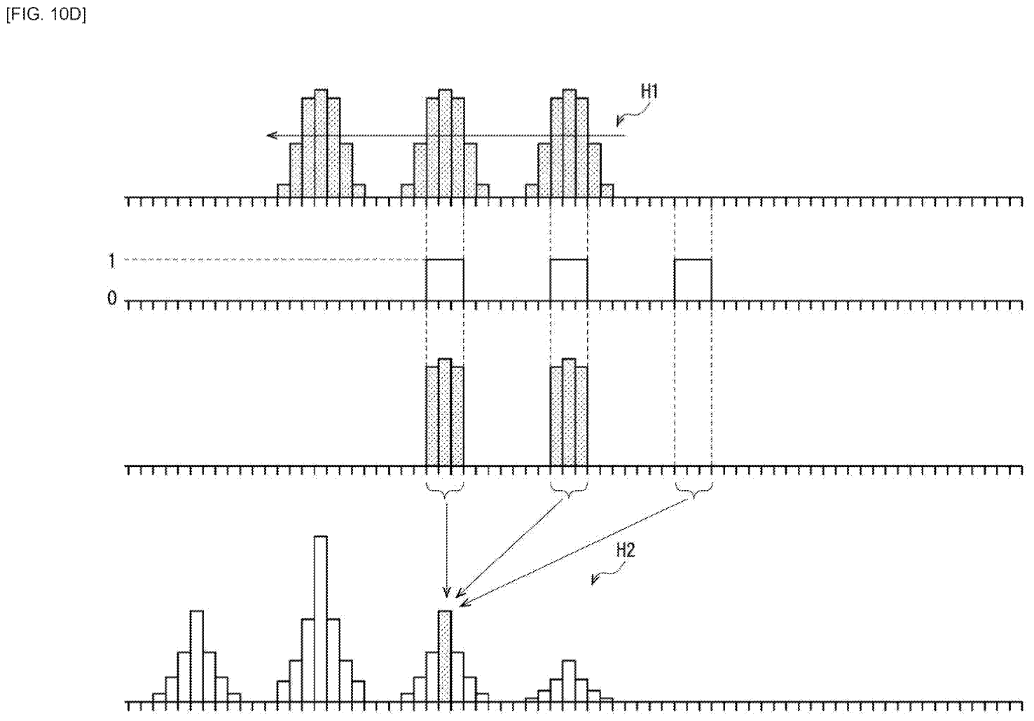

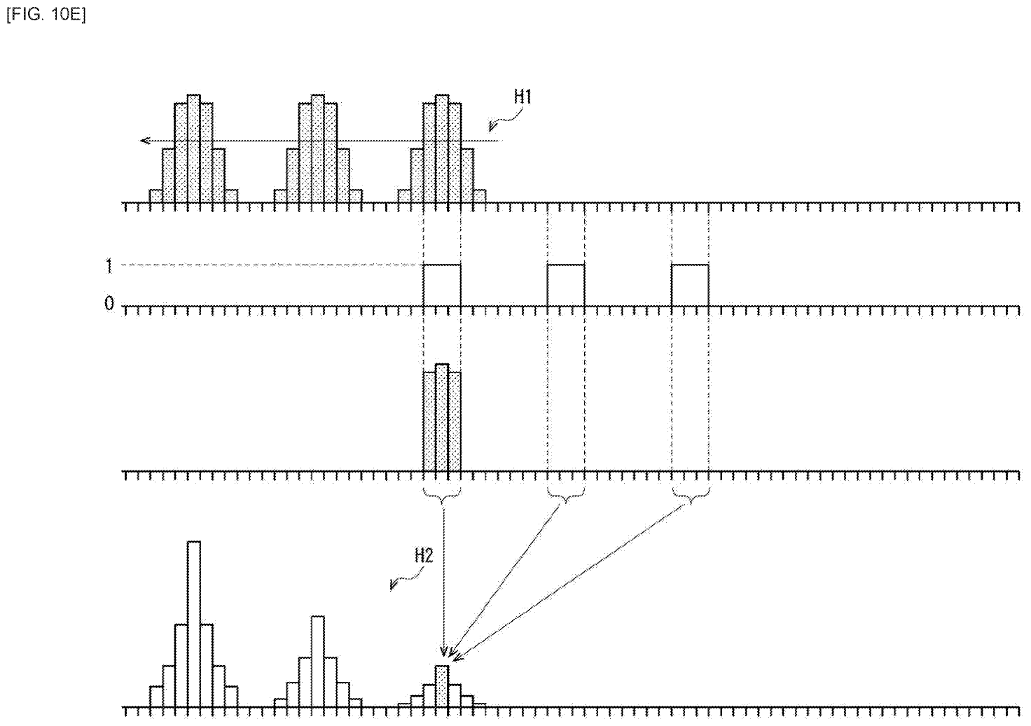

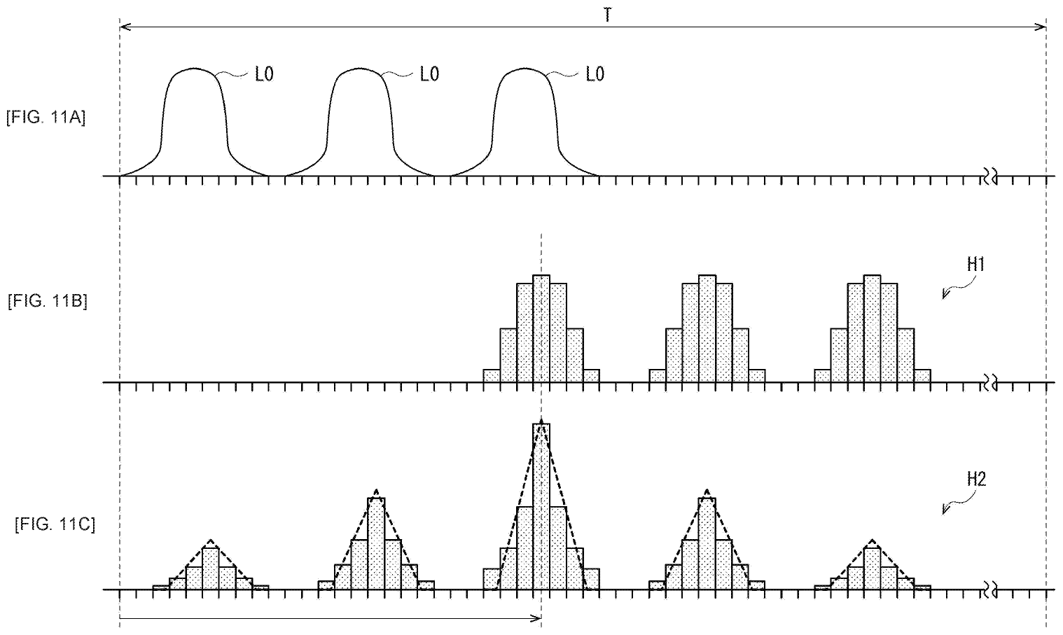

FIGS. 10A to 10E illustrate an example of filter processing using the filter coefficient pattern illustrated in FIG. 7, where a top illustrates a histogram H1, a second stage from the top illustrates the filter coefficient pattern, a third stage from the top illustrates a result of multiplying a frequency value (a count value) in the histogram H1 by a filter coefficient of the filter coefficient pattern, and a fourth stage from the top illustrates a result of the filter processing.

As indicated by an arrow, the histogram H1 moves from a right side of the filter coefficient pattern toward left one by one on a scale, similar to the case described with reference to FIG. 9. As the histogram H1 moves, as illustrated in FIGS. 10A to 10E, a portion in the histogram H1, which is overlapping with a range where the filter coefficient is “1”, changes. Thereby, such a histogram H2 as illustrated at a bottom stage in each of FIGS. 10A to 10E is generated. In this example, matching of a pattern of the histogram H1 and the filter coefficient pattern with each other is thus attained, making it possible to allow a peak of the histogram H2 to be higher in the case illustrated in FIG. 10C, for example.

FIG. 11 illustrates an operation example of the photodetection system 1 in a case where the filter processing illustrated in FIGS. 10A to 10E is performed, where (A) indicates a waveform of light emitted by the light-emitting section 12, (B) indicates an example of a histogram H1, and (C) indicates an example of a histogram H2. In this example, five ranges of distribution occur in the histogram H2, as illustrated in (C) in FIG. 11. The five ranges of distribution respectively correspond to steps of the processing, which are respectively illustrated in (A) to (E) in FIG. 10. A peak of the histogram H2 appears in one of the five ranges of distribution, which lies at a middle position. A position of the peak is a position in accordance with a distance between the photodetection system 1 and the measurement target.

In this way, the filter processing section 23 generates one histogram H2 on the basis of one histogram H1. The filter processing section 23 performs such processing as described above on the basis of each of a plurality of histograms H1 to generate each of a plurality of histograms H2. The filter processing section 23 then supplies the histograms H2 to the distance arithmetic section 24.

The distance arithmetic section 24 is configured to calculate, on the basis of each of the plurality of histograms H2, a time of flight of light, during which light pulses move back and forth between the photodetection system 1 and a measurement target, and to calculate a distance value in each of the plurality of light-receiving sections P on the basis of the time of flight of light. Specifically, the distance arithmetic section 24 detects a representative value of frequency values in a histogram H2 to calculate a time of flight of light, for example. The distance arithmetic section 24 is able to regard a peak value of one of the frequency values as a representative value of the frequency values, for example. The distance arithmetic section 24 then calculates a value of a distance between the photodetection system 1 and the measurement target on the basis of the time of flight of light. The distance arithmetic section 24 outputs distance data DT including data of the distance value of each of the plurality of light-receiving sections P.

The distance measurement control section 25 is configured to control operation of the light emission control section 11, the histogram generation section 22, the filter processing section 23, and the distance arithmetic section 24 to control operation of the photodetection system 1. Furthermore, the distance measurement control section 25 has a function of generating clock signals CLK and CLK2 to be used in the photodetection system 1.

Note herein that the photodiode PD corresponds to a specific example of a “light-receiving element” in the present disclosure. The histogram generation section 22 corresponds to a specific example of a “histogram generation circuit” in the present disclosure. The filter processing section 23 corresponds to a specific example of a “filter circuit” in the present disclosure. The distance arithmetic section 24 corresponds to a specific example of a “representative value calculation circuit” in the present disclosure. The distance measurement control section 25 corresponds to a specific example of a “setting circuit” in the present disclosure. The adder circuit ADD corresponds to a specific example of an “adder circuit” in the present disclosure. The detection signal Sdet corresponds to a specific example of a “detection signal” in the present disclosure. The histogram H1 corresponds to a specific example of a “first histogram” in the present disclosure. The histogram H2 corresponds to a specific example of a “second histogram” in the present disclosure. The photodetection period T corresponds to a specific example of a “photodetection period” in the present disclosure.

### Operation and Effects

Next, operation and effects of the photodetection system 1 according to the present embodiment will now be described herein.

### (Outline of Overall Operation)

An outline of overall operation of the photodetection system 1 will first be described herein with reference to FIG. 1. The light emission control section 11 controls operation of the light-emitting section 12 on the basis of an instruction from the distance measurement control section 25 in the photodetection unit 20. The light-emitting section 12 emits, on the basis of an instruction from the light emission control section 11, a plurality of light pulses L0 having a predetermined pulse pattern toward a measurement target. As the light-receiving sections P in the pixel array 21 in the photodetection unit 20 detect light, the light-receiving sections P each generate a detection signal Sdet. The histogram generation section 22 generates, on the basis of an instruction from the distance measurement control section 25, a histogram H1 about detection timings of reflected light pulses L1 in each of the light-receiving sections P. The filter processing section 23 performs filter processing on the histogram H1 to generate a histogram H2. The distance arithmetic section 24 calculates a time of flight of light on the basis of the histogram H2 to calculate a distance value in each of the light-receiving sections P on the basis of the time of flight of light. The distance arithmetic section 24 then outputs distance data DT including data of the distance value of each of the plurality of light-receiving sections P. The distance measurement control section 25 controls operation of the light emission control section 11, the histogram generation section 22, the filter processing section 23, and the distance arithmetic section 24 to control operation of the photodetection system 1.

### Detailed Operation

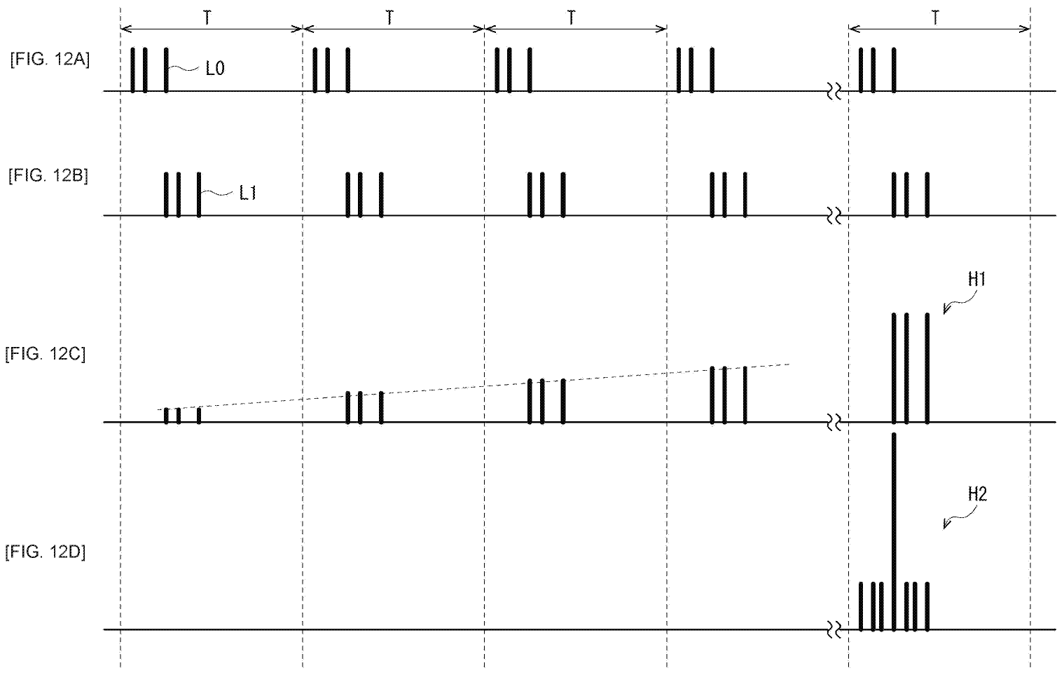

FIG. 12 illustrates an operation example of the photodetection system 1, where (A) indicates a waveform of light emitted by the light-emitting section 12, (B) indicates a waveform of incident light into the light-receiving section P, (C) indicates distribution of count values CNT1 to CNT100 of the histogram generation section 22, and (D) indicates a histogram H2.

In the photodetection system 1, the distance measurement control section 25 sets a plurality of photodetection periods T. In this example, time lengths of the plurality of photodetection periods T are equal to each other. The distance measurement control section 25 causes the light-emitting section 12 to emit light in the pulse pattern illustrated in (B) in FIG. 2 in this example. The light emission control section 11 controls operation of the light-emitting section 12 on the basis of an instruction from the distance measurement control section 25. The light-emitting section 12 emits three light pulses L0 having the pulse pattern illustrated in (B) in FIG. 2 toward a measurement target in each of the plurality of detection periods T ((A) in FIG. 12).

The light pulses L0 emitted from the photodetection system 1 are reflected by the measurement target. Light pulses reflected by the measurement target (reflected light pulses L1) then enter each of the light-receiving sections P in the photodetection unit 20 ((B) in FIG. 12). In each of the plurality of detection periods T, timings of the three reflected light pulses L1 are timings each delayed by a time in accordance with a distance from the photodetection system 1 to the measurement target from each of the timings of the three light pulses L0.

The light-receiving sections P detect the reflected light pulses L1 to each generate a detection signal Sdet. The 100 accumulators AC1 to AC100 in the histogram generation section 22 respectively generate count values CNT1 to CNT100 on the basis of the detection signal Sdet ((C) in FIG. 12). The count values CNT1 to CNT100 are cumulatively added respectively in the plurality of photodetection periods T. Thereby, each time the three reflected light pulses L1 are detected, a plurality of count values, which corresponds to the three reflected light pulses L1, among the count values CNT1 to CNT100 increases gradually, as illustrated in (C) in FIG. 12. As a final photodetection period T ends, the histogram generation section 22 then outputs the cumulatively added count values CNT1 to CNT100 as a histogram H1.

The filter processing section 23 performs filter processing on the histogram H1 generated in this way to generate a histogram H2 ((D) in FIG. 12). The distance measurement control section 25 causes the filter processing section 23 to operate in the filter coefficient pattern illustrated in (B) in FIG. 7, which corresponds to the pulse pattern illustrated in (B) in FIG. 2. Matching of the pattern based on the reflected light pulses L1 in the histogram H1 and the filter coefficient pattern in the filter processing section 23 with each other is thus attained, allowing the histogram H2 to have a higher peak, as illustrated in (D) in FIG. 12. The distance arithmetic section 24 calculates a time of flight of light on the basis of the histogram H2 to calculate a distance value in each of the light-receiving sections P on the basis of the time of flight of light.

In this example, the photodetection system 1 has detected the three reflected light pulses L1 in accordance with the three light pulses L0 that the photodetection system 1 itself has emitted. There may be a case where the photodetection system 1 further detects a plurality of light pulses emitted from another photodetection system 1A, for example. Operation in this case will now be described herein.

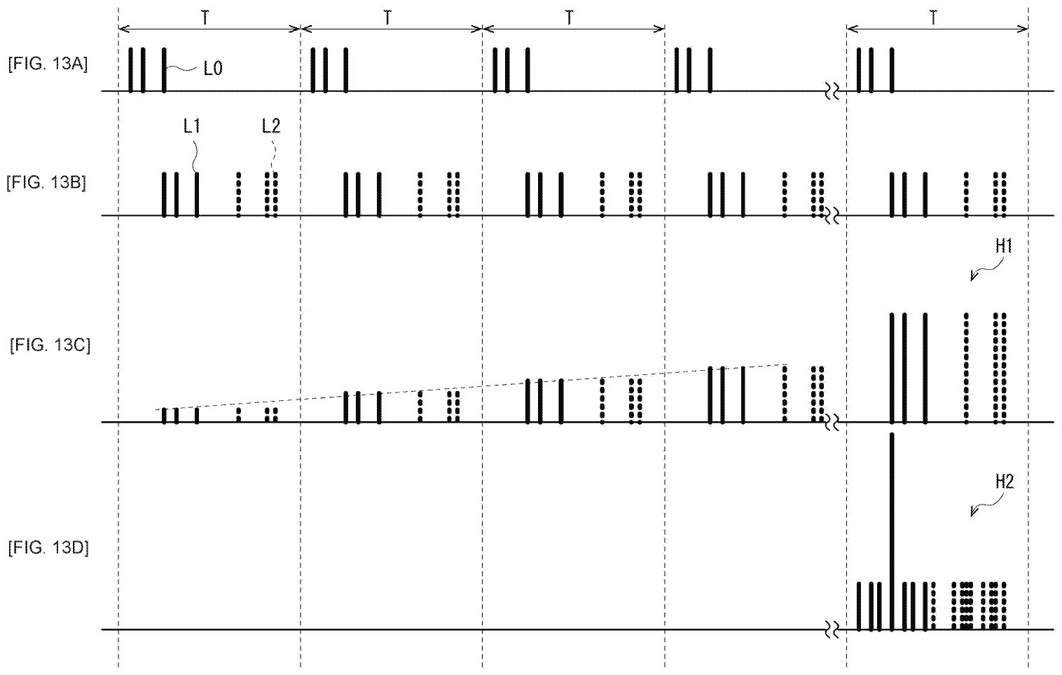

FIG. 13 illustrates another operation example of the photodetection system 1. FIG. 13 illustrates, with dotted lines, light pulses that the photodetection system 1A that differs from the photodetection system 1 has emitted and histograms based on the light pulses.

In each of a plurality of photodetection periods T in this example, a plurality of light pulses L2 emitted from the photodetection system 1A that differs from the photodetection system 1 enters each of the light-receiving sections P ((B) in FIG. 13). In this example, the photodetection system 1A emits three light pulses L2 in a photodetection period having a time length that is identical to that of each of the photodetection periods T of the photodetection system 1. A pulse pattern in the photodetection system 1A differs from a pulse pattern in the photodetection system 1.

The light-receiving sections P detect the reflected light pulses L1 and the light pulses L2 to each generate a detection signal Sdet. The 100 accumulators AC1 to AC100 in the histogram generation section 22 respectively generate count values CNT1 to CNT100 on the basis of the detection signal Sdet ((C) in FIG. 13). Thereby, the plurality of count values corresponding to the three light pulses L2 each increases gradually. As a final photodetection period T ends, the histogram generation section 22 then outputs the cumulatively added count values CNT1 to CNT100 as a histogram H1.

The filter processing section 23 performs filter processing on the histogram H1 generated in this way to generate a histogram H2 ((D) in FIG. 13). Matching of the pattern based on the light pulses L2 in the histogram H1 and the filter coefficient pattern in the filter processing section 23 with each other is however not attained. Therefore, even such light pulses L2 enter, no higher peak appears in the histogram H2, as illustrated in FIG. 13. Therefore, the distance arithmetic section 24 calculates a time of flight of light on the basis of a portion in the histogram H2, which pertains to the reflected light pulses L1, to calculate a distance value in each of the light-receiving sections P on the basis of the time of flight of light. Even in a case where a plurality of light pulses L2 emitted from the photodetection system 1A that differs from the photodetection system 1 enters the photodetection system 1, it is possible to reduce a possibility that distance measuring accuracy lowers, as described above.

Furthermore, there may be a case where cyclic, strong interference light enters the photodetection system 1, for example. Operation in this case will now be described herein.

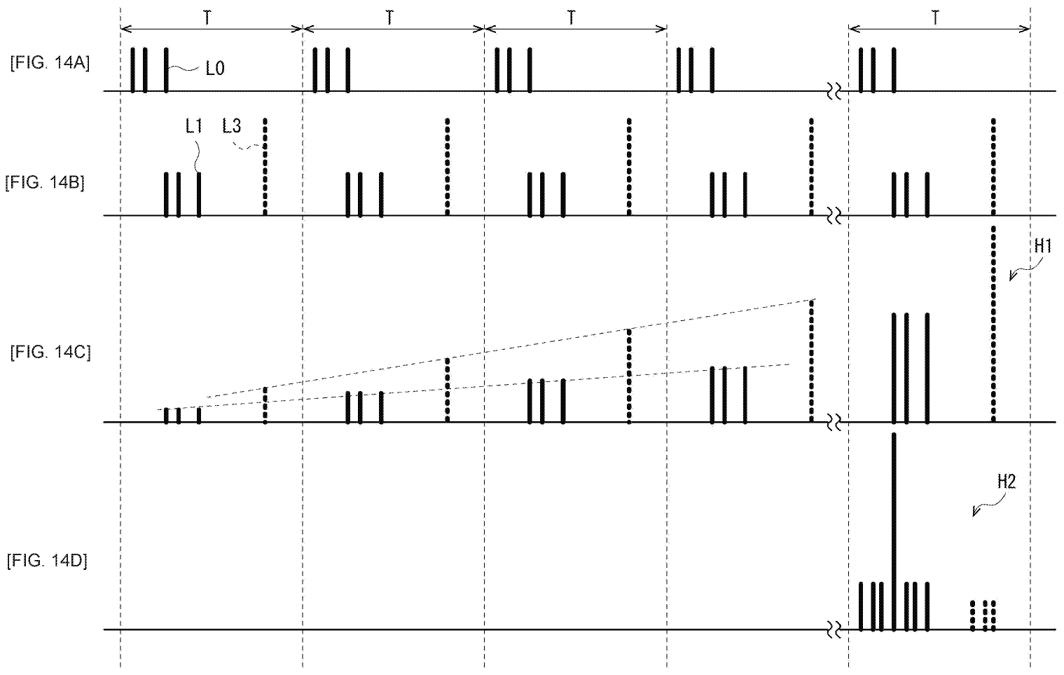

FIG. 14 illustrates still another operation example of the photodetection system 1. FIG. 14 illustrates, with dotted lines, a histogram based on such interference light.

In this example, interference light L3 enters each of the light-receiving sections P in each of a plurality of photodetection periods T ((B) in FIG. 14). In this example, the interference light L3 occurs at a constant cycle identical to each of the photodetection periods T in the photodetection system 1. The light-receiving sections P detect reflected light pulses L1 and the interference light L3 to each generate a detection signal Sdet. The 100 accumulators AC1 to AC100 in the histogram generation section 22 respectively generate count values CNT1 to CNT100 on the basis of the detection signal Sdet ((C) in FIG. 14). Thereby, the count values corresponding to the interference light L3 increase gradually. As a final photodetection period T ends, the histogram generation section 22 then outputs the cumulatively added count values CNT1 to CNT100 as a histogram H1. Since the interference light L3 is stronger than the reflected light pulses L1 in this example ((B) in FIG. 14), one of the count values, which pertains to the interference light L3, becomes largest even in the histogram H1, as illustrated in (C) in FIG. 14.

The filter processing section 23 performs filter processing on the histogram H1 generated in this way to generate a histogram H2 ((D) in FIG. 14). As will be described later in detail, the filter processing section 23 excludes a maximum value detected by the maximum value detection part 33 from targets that are subject to the filter processing to reduce a component in accordance with the interference light in a histogram H2. Thereby, the photodetection system 1 is able to prevent its distance measuring accuracy from lowering even in a case where there is interference light.

The maximum value detection part 33 in the filter processing section 23 detects, on the basis of an instruction from the distance measurement control section 25, a maximum value among two or more output values among a plurality of output values outputted from the shift register 31. The maximum value detection part 33 then provides, to the removing part 34, an instruction of removing a value corresponding to the maximum value among a plurality of values outputted by the multiplying part 32. The removing part 34 replaces, on the basis of an instruction from the maximum value detection part 33, the value corresponding to the maximum value detected by the maximum value detection part 33 among the plurality of values supplied from the multiplying part 32 with “0”, and outputs the replaced value, while outputting the others of the plurality of values as is.

The distance measurement control section 25 sets, for the maximum value detection part 33, two or more output values serving as processing targets Rmax for detecting a maximum value among a plurality of output values outputted from the shift register 31. The maximum value detection part 33 detects a maximum value on the basis of the two or more output values serving as the processing targets Rmax, which are set by the distance measurement control section 25. For the processing targets Rmax, there may be various setting methods. Operation of the photodetection system 1 in each of such various setting methods will now be described herein.

### Operation Example E1

In Operation Example E1, the distance measurement control section 25 sets two or more output values where a filter coefficient is “1” among a plurality of output values outputted from the shift register 31 as processing targets Rmax for detecting a maximum value.

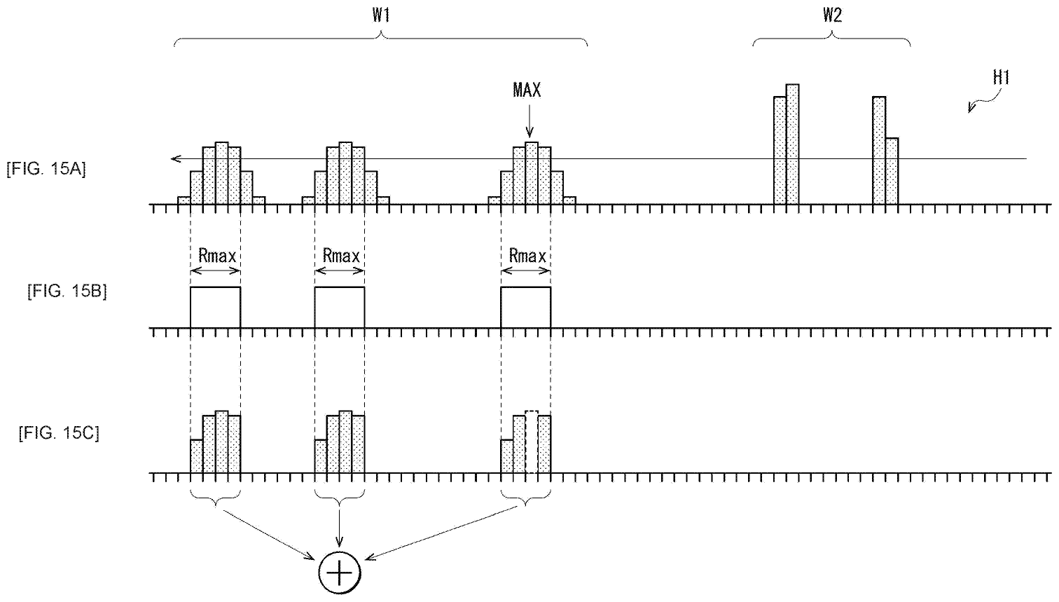

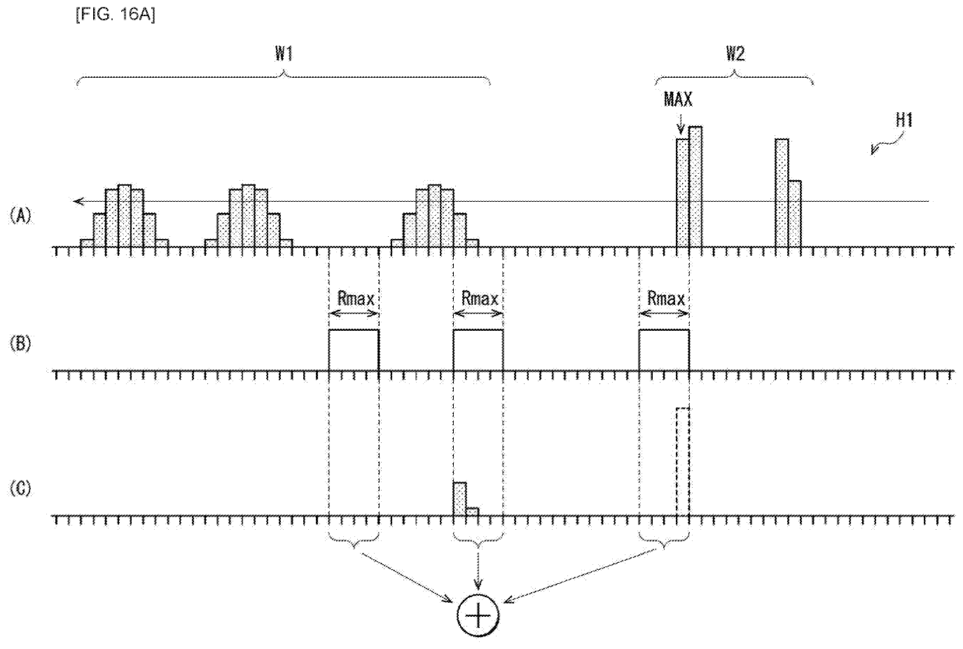

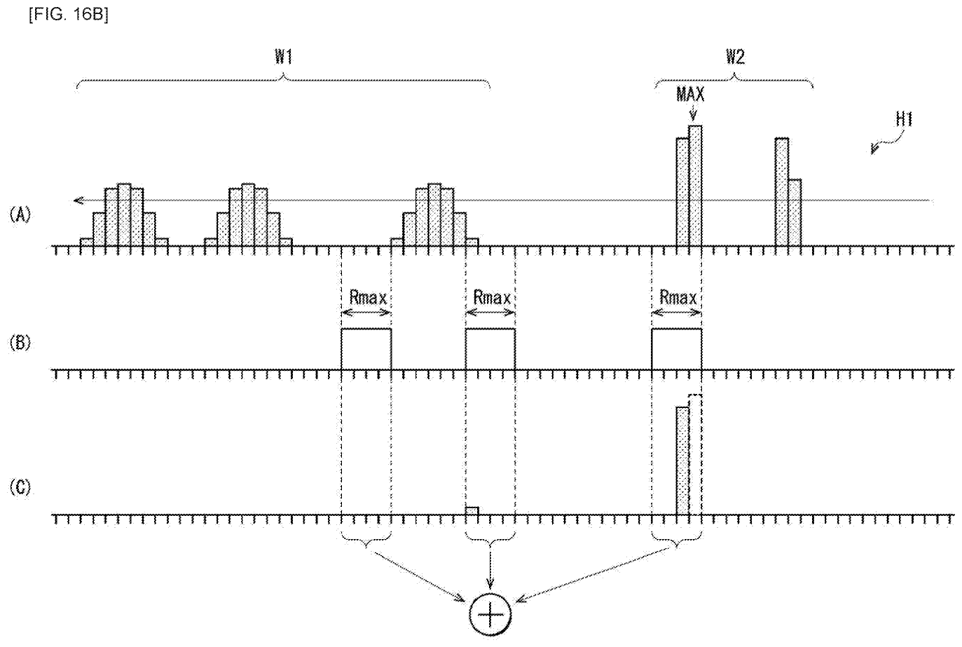

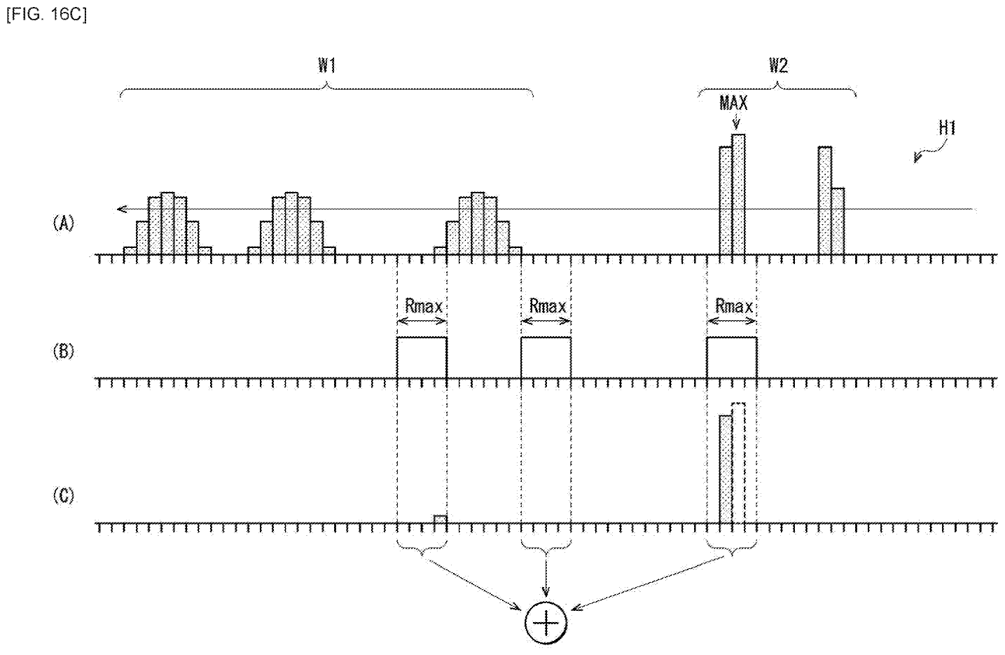

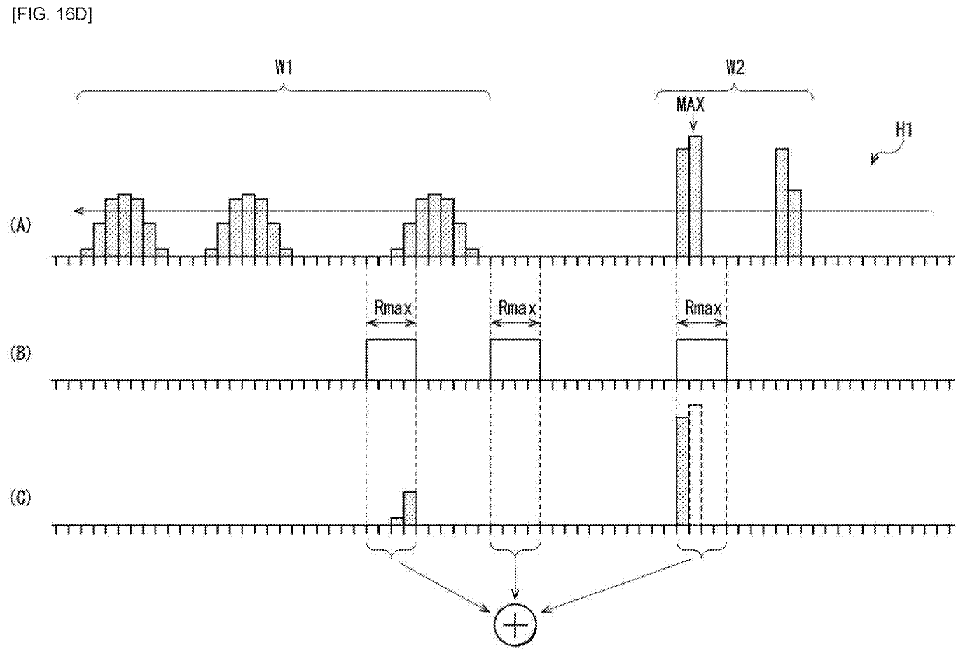

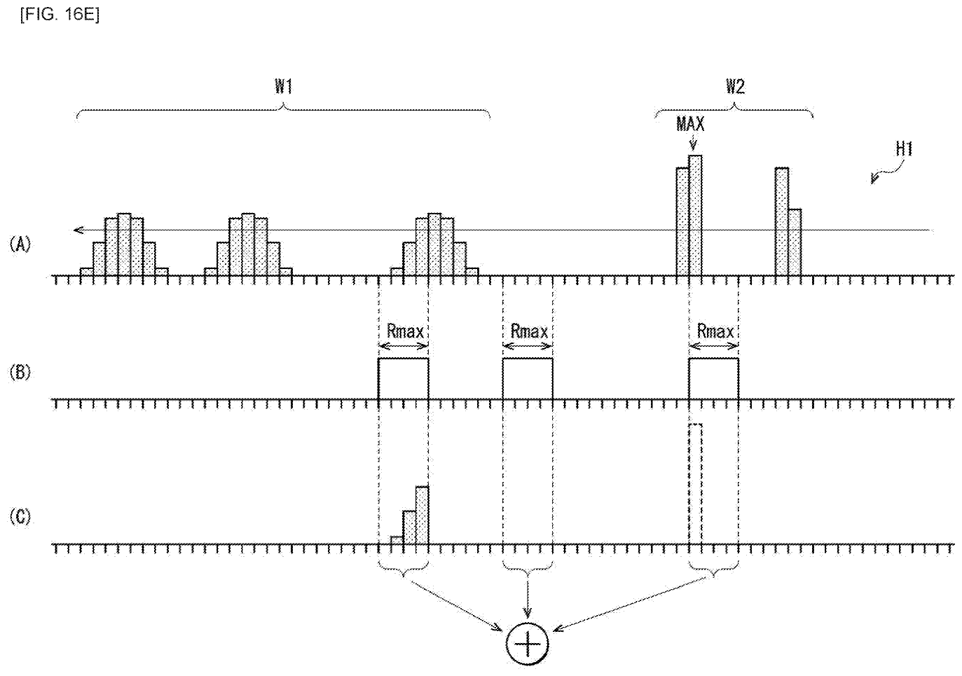

FIGS. 15 and 16A to 16E illustrate an operation example of the photodetection system 1, according to Operation Example E1. In each of FIGS. 15 and 16A to 16E, (A) indicates a histogram H1, (B) indicates a filter coefficient pattern in the filter processing section 23, and (C) indicates a result of multiplying a frequency value (a count value) in the histogram H1 by a filter coefficient of the filter coefficient pattern. In Operation Example E1, as illustrated in FIGS. 15 and 16A to 16E, 12 output values where the filter coefficient is “1” among a plurality of output values outputted from the shift register 31 are set as processing targets Rmax for detecting a maximum value.

The histogram H1 includes a portion W1 pertaining to three reflected light pulses L1 and a portion W2 pertaining to interference light L3. As indicated by an arrow, the histogram H1 moves from a right side of the filter coefficient pattern toward left one by one on a scale.

In FIG. 15, the portion W1 in the histogram H1 is overlapping with regions where the filter coefficient is “1” in the filter coefficient pattern ((A) and (B) in FIG. 15). The maximum value detection part 33 detects a maximum value among the 12 frequency values serving as the processing targets Rmax for detecting a maximum value in the histogram H1. In this example, a peak value in one of the three ranges of distribution in the portion W1, which lies at a rightmost position, represents a maximum value MAX. The removing part 34 then replaces, on the basis of an instruction from the maximum value detection part 33, a value corresponding to the maximum value MAX among a plurality of values outputted by the multiplying part 32 with “0”, and outputs the replaced value ((C) in FIG. 15). The adding part 35 then adds the 12 values outputted from the removing part 34 to each other.

In FIGS. 16A to 16E, as the histogram H1 moves toward the left, a relative positional relationship between the histogram H1 and the filter coefficient pattern changes, and the portion W2 in the histogram H1 is overlapping with one of the regions where the filter coefficient is “1” in the filter coefficient pattern. In FIGS. 16A to 16E, one of four frequency values in the portion W2 represents a maximum value MAX. The removing part 34 then replaces, on the basis of an instruction from the maximum value detection part 33, a value corresponding to the maximum value MAX among a plurality of values outputted by the multiplying part 32 with “0”, and outputs the replaced value ((C) in FIG. 16A, (C) in FIG. 16B, (C) in FIG. 16C, (C) in FIG. 16D, and (C) in FIG. 16E). The adding part 35 then adds the 12 values outputted from the removing part 34 to each other.

In the photodetection system 1, as described above, a maximum value detected by the maximum value detection part 33 is excluded from targets that are subject to the filter processing. Thereby, in the photodetection system 1, it is possible to reduce a component in accordance with this interference light in a histogram H2, making it possible to prevent its distance measuring accuracy from lowering due to the interference light.

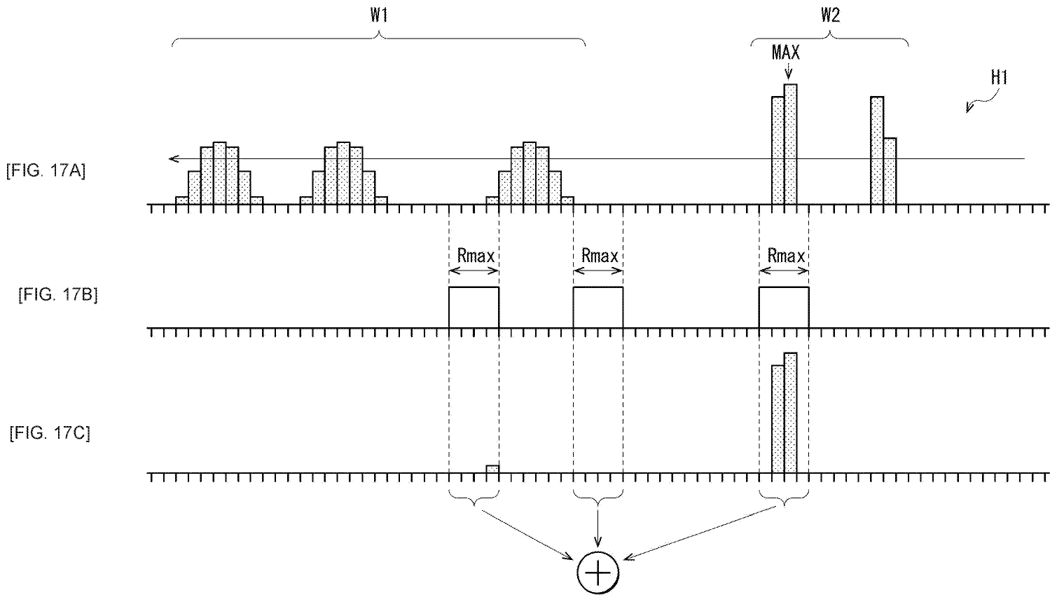

That is, in a case where the maximum value detection part 33 and the removing part 34 are not provided, for example, no maximum value is excluded from targets that are subject to the filter processing, as illustrated in FIG. 17. FIG. 17 is a diagram corresponding to FIG. 16C. In (C) in FIG. 17, a component in accordance with a maximum value MAX is not removed but remaining in a result of multiplying a frequency value (a count value) in a histogram H1 by a filter coefficient of a filter coefficient pattern, differently from (C) in FIG. 16C. Therefore, a value acquired by adding 12 values to each other by the adding part 35 includes the component in accordance with the maximum value MAX. In a case where a maximum value MAX is greater, there may also be a case where interference light L3 forms a peak value in a histogram H2. That is, in this case, reflected light pulses L1 do not form a peak value in the histogram H2. In this case, distance measuring accuracy lowers.

In the present embodiment, on the other hand, the maximum value detection part 33 and the removing part 34 are provided, and a maximum value detected by the maximum value detection part 33 is excluded from targets that are subject to the filter processing, as illustrated in FIGS. 16A to 16E, for example. As a result, reflected light pulses L1 form a peak value in a histogram H2, making it possible to prevent distance measuring accuracy from lowering, even in a case where there is interference light.

### Operation Example E2

In Operation Example E2, the distance measurement control section 25 sets one output value in each of three portions where a filter coefficient is “1” among a plurality of output values outputted from the shift register 31 as a processing target Rmax for detecting a maximum value.

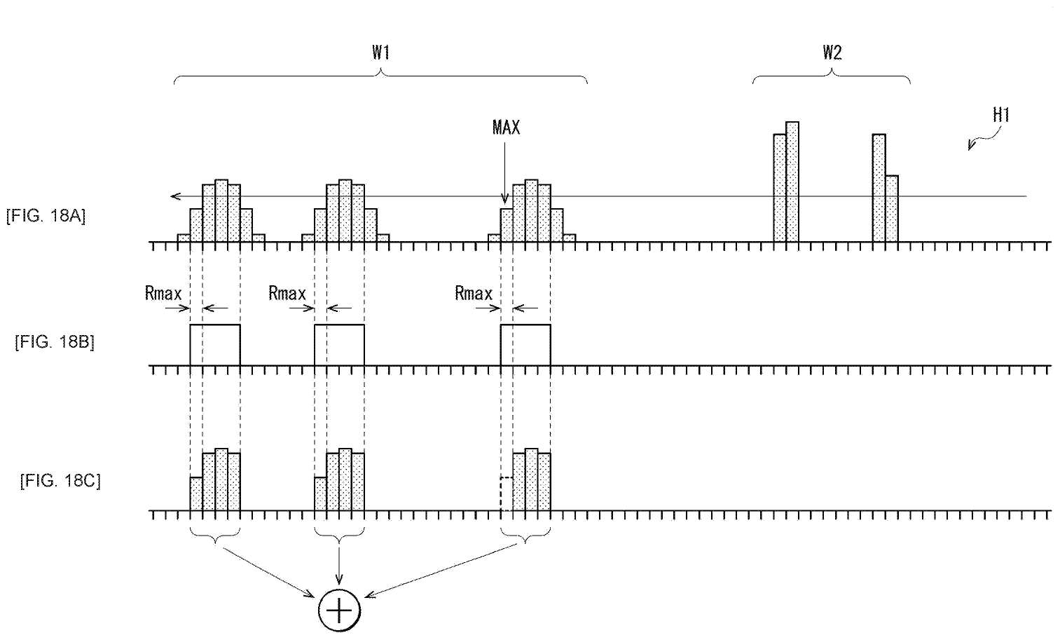

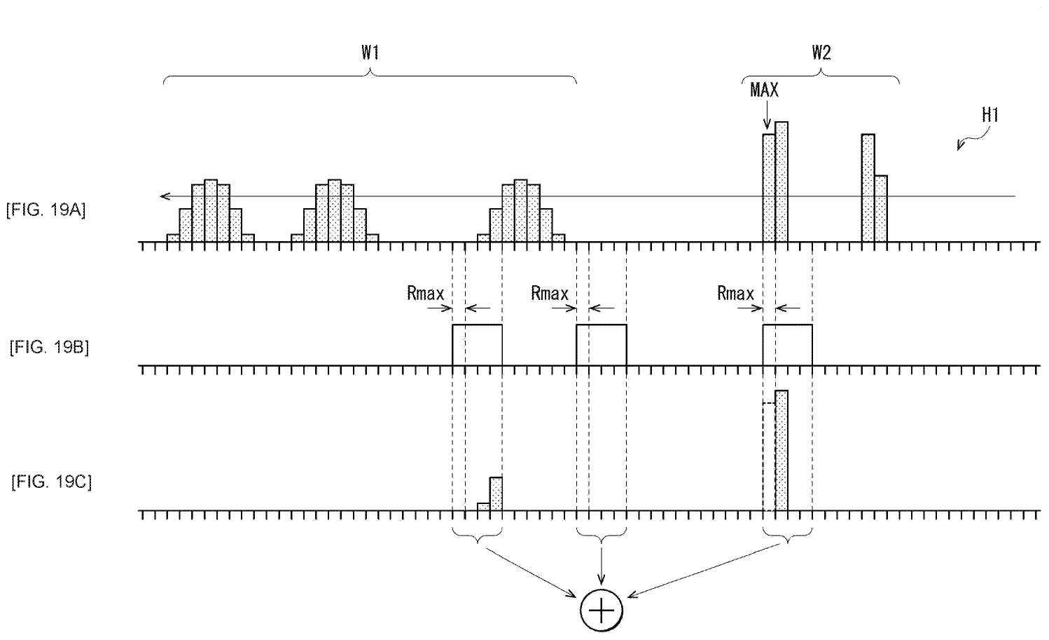

FIGS. 18 and 19 illustrate an operation example of the photodetection system 1, according to Operation Example E2. In Operation Example E2, as illustrated in FIGS. 18 and 19, one output value in each of three portions where a filter coefficient is “1” among a plurality of output values outputted from the shift register 31 is set as a processing target Rmax for detecting a maximum value. In this example, the output value at a leftmost position in each of the three portions where the filter coefficient is “1” is set as a processing target Rmax.

In FIG. 18, a portion W1 in a histogram H1 is overlapping with regions where the filter coefficient is “1” in a filter coefficient pattern ((A) and (B) in FIG. 18). The maximum value detection part 33 detects a maximum value among the three frequency values serving as the processing targets Rmax for detecting a maximum value in the histogram H1. In this example, a value in one of the three ranges of distribution in the portion W1, which lies at a rightmost position, represents a maximum value MAX. The removing part 34 then replaces, on the basis of an instruction from the maximum value detection part 33, a value corresponding to the maximum value MAX among a plurality of values outputted by the multiplying part 32 with “0”, and outputs the replaced value ((C) in FIG. 18). The adding part 35 then adds the 12 values outputted from the removing part 34 to each other.

In FIG. 19, a portion W2 in the histogram H1 is overlapping with a region where the filter coefficient is “1” in the filter coefficient pattern. In FIG. 19, one of four frequency values in the portion W2 represents a maximum value MAX. The removing part 34 then replaces, on the basis of an instruction from the maximum value detection part 33, a value corresponding to the maximum value MAX among a plurality of values outputted by the multiplying part 32 with “0”, and outputs the replaced value ((C) in FIG. 18). The adding part 35 then adds the 12 values outputted from the removing part 34 to each other.

In the photodetection system 1, as described above, a maximum value detected by the maximum value detection part 33 is excluded from targets that are subject to the filter processing. Thereby, in the photodetection system 1, it is possible to reduce a component in accordance with this interference light in a histogram H2, making it possible to prevent its distance measuring accuracy from lowering due to the interference light.

### Operation Example E3

In Operation Example E3, the distance measurement control section 25 sets all of a plurality of output values outputted from the shift register 31 as processing targets Rmax for detecting a maximum value.

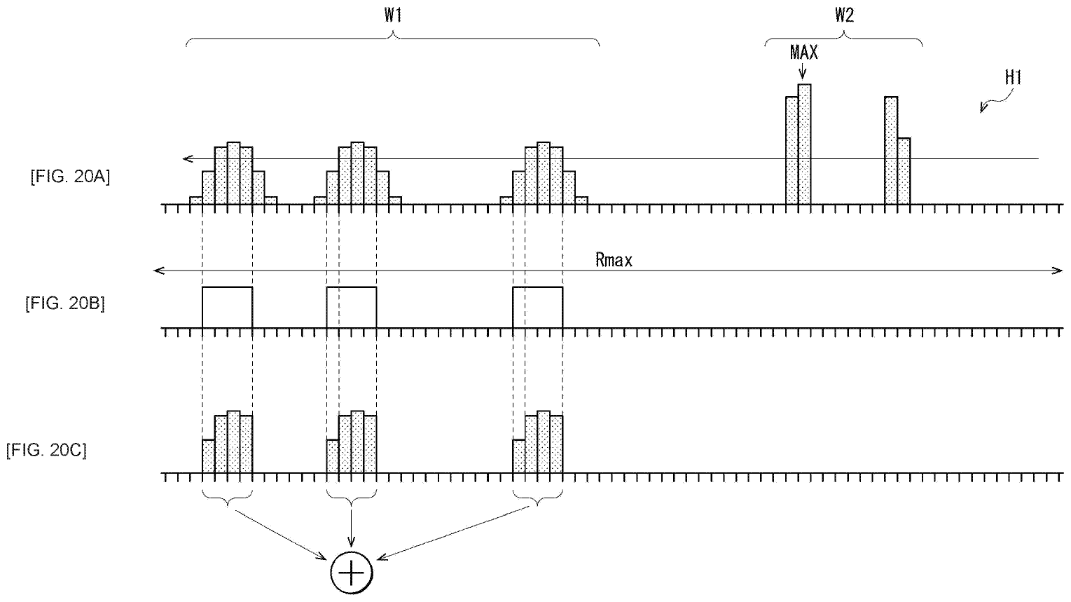

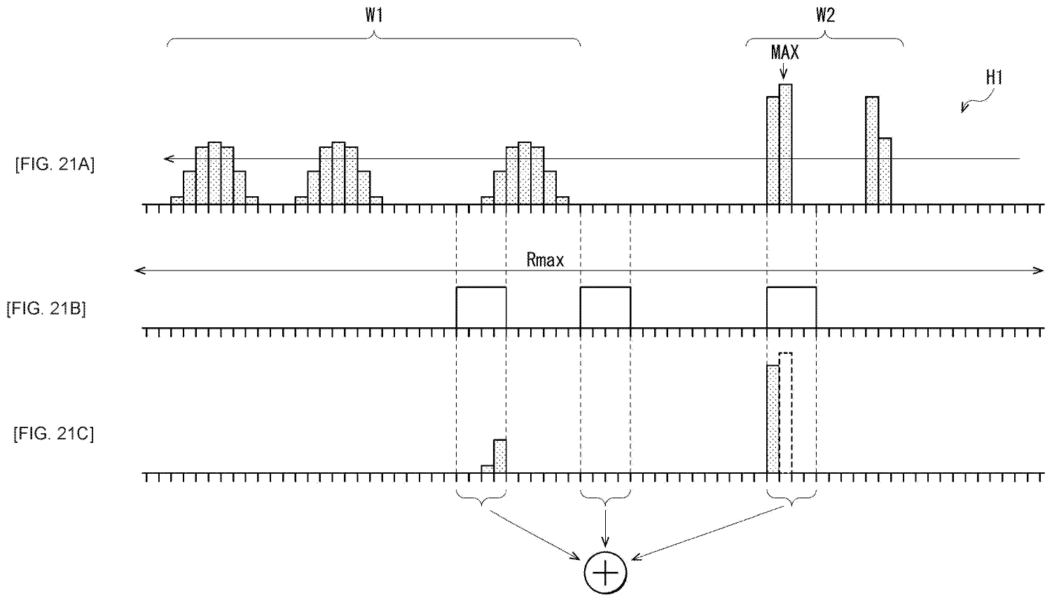

FIGS. 20 and 21 illustrate an operation example of the photodetection system 1, according to Operation Example E3. In Operation Example E3, as illustrated in FIGS. 20 and 21, all of a plurality of output values outputted from the shift register 31 are set as processing targets Rmax for detecting a maximum value.

In FIG. 20, a portion W1 in a histogram H1 is overlapping with regions where a filter coefficient is “1” in a filter coefficient pattern ((A) and (B) in FIG. 20). The maximum value detection part 33 detects a maximum value among the plurality of frequency values serving as the processing targets Rmax for detecting a maximum value in the histogram H1. In this example, a value in a portion W2 represents a maximum value MAX. In FIG. 20, the maximum value MAX is not overlapping with a portion where the filter coefficient is “1”. Therefore, the removing part 34 outputs a plurality of values that the multiplying part 32 outputs as is ((C) in FIG. 20). The adding part 35 then adds the 12 values outputted from the removing part 34 to each other.

In FIG. 21, the portion W2 in the histogram H1 is overlapping with a region where the filter coefficient is “1” in the filter coefficient pattern. The removing part 34 replaces, on the basis of an instruction from the maximum value detection part 33, a value corresponding to the maximum value MAX among a plurality of values outputted by the multiplying part 32 with “0”, and outputs the replaced value ((C) in FIG. 21). The adding part 35 then adds the 12 values outputted from the removing part 34 to each other.

In the photodetection system 1, as described above, a maximum value detected by the maximum value detection part 33 is excluded from targets that are subject to the filter processing. Thereby, in the photodetection system 1, it is possible to reduce a component in accordance with this interference light in a histogram H2, making it possible to prevent its distance measuring accuracy from lowering due to the interference light.

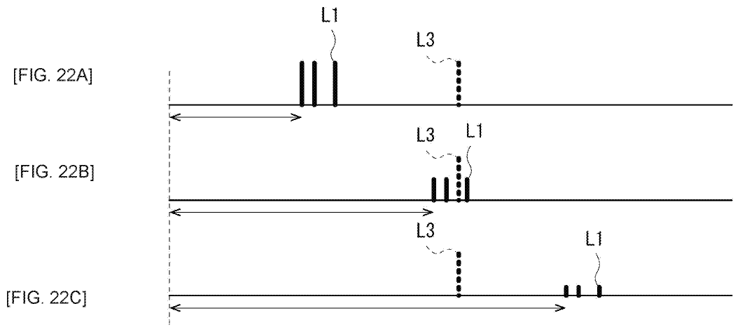

FIG. 22 illustrates an operation example of the photodetection system 1, where (A) indicates a case where a distance between the photodetection system 1 and a measurement target is shorter, (B) indicates a case where a distance between the photodetection system 1 and a measurement target is at a medium level, and (A) indicates a case where a distance between the photodetection system 1 and a measurement target is longer. As illustrated in (A) to (C) in FIG. 22, in a case where a distance between the photodetection system 1 and the measurement target is shorter, light intensity of reflected light pulses L1 is stronger, and, in a case where the distance is longer, the light intensity of the reflected light pulses L1 is weaker. Even in a case where the light intensity of the reflected light pulses L1 is weaker, a maximum value detected by the maximum value detection part 33 is excluded from targets that are subject to the filter processing in the photodetection system 1, as described above, making it possible to prevent its distance measuring accuracy from lowering due to interference light L3. As a result, it is possible to extend a distance that the photodetection system 1 is able to measure.

As described above, the photodetection system 1 includes: the photodiode PD that is able to detect a plurality of reflected light pulses L1 having a predetermined pulse pattern; the histogram generation section 22 that is able to generate a first histogram (a histogram H1) on the basis of detection timings in the photodiode PD; the filter processing section 23 that is able to perform, on the basis of the histogram H1, filter processing using a filter coefficient pattern in accordance with the pulse pattern to generate a second histogram (a histogram H2); and the distance arithmetic section 24 that is able to calculate a representative value of the detection timings on the basis of the second histogram (the histogram H2). The filter processing section 23 excludes a first frequency value representing a maximum value among two or more frequency values in the first histogram (the histogram H1) from targets that are subject to the filter processing. Thereby, in the photodetection system 1, it is possible to reduce a component in accordance with interference light in the histogram H2, making it possible to prevent its distance measuring accuracy from lowering even in a case where there is interference light.

### Effects

It has been described, as described above, that the present embodiment is provided with: the photodiode that is able to detect a plurality of reflected light pulses having a predetermined pulse pattern; the histogram generation section that is able to generate a histogram on the basis of detection timings in the photodiode; the filter processing section that is able to perform, on the basis of the first histogram, filter processing using a filter coefficient pattern in accordance with the pulse pattern to generate a second histogram; and the distance arithmetic section that is able to calculate a representative value of the detection timings on the basis of the second histogram. The filter processing section then excludes a first frequency value representing a maximum value among two or more frequency values in the first histogram from targets that are subject to the filter processing. Thereby, it is possible to prevent its distance measuring accuracy from lowering even in a case where there is interference light.

### Modification Example 1

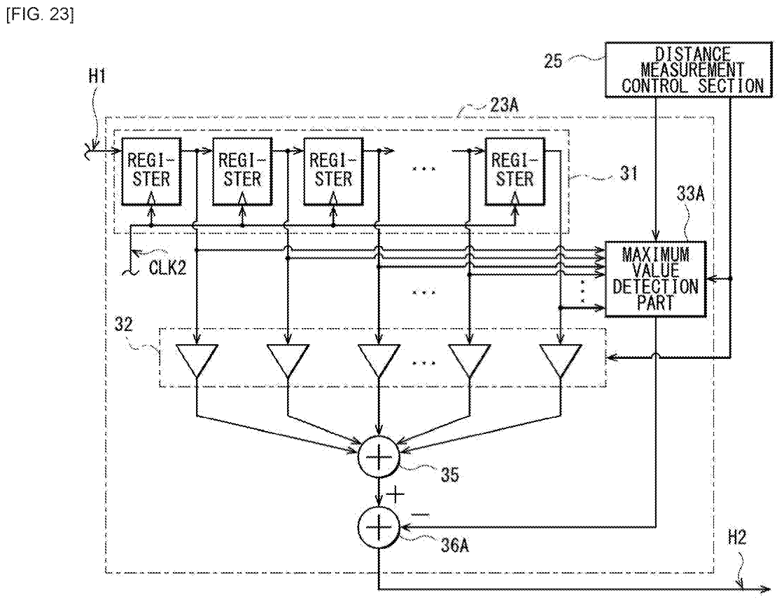

In the filter processing section 23 according to the embodiment described above, as illustrated in FIG. 6, the removing part 34 has replaced, on the basis of an instruction from the maximum value detection part 33, a value corresponding to a maximum value detected by the maximum value detection part 33 among a plurality of values supplied from the multiplying part 32 with “0”. However, the present disclosure is not limited to the embodiment. Instead of this action described in the embodiment, the removing part 34 may not be provided, and a value corresponding to a maximum value may be subtracted from a result of a detection by the adding part 35, similar to a filter processing section 23A illustrated in FIG. 23, for example. The filter processing section 23A includes a maximum value detection part 33A and an adding part 36A. The maximum value detection part 33A is configured to detect, on the basis of an instruction from the distance measurement control section 25, and on the basis of two or more output values among a plurality of output values outputted from the shift register 31, a maximum value among the two or more output values. The maximum value detection part 33A then multiplies the maximum value by a filter coefficient corresponding to the maximum value included in a filter coefficient pattern, and supplies a result of the multiplication to the adding part 36A. The adding part 36A is configured to subtract a value supplied from the maximum value detection part 33A from a result of an addition by the adding part 35. Even with this configuration, the filter processing section 23A is able to exclude a maximum value detected by the maximum value detection part 33A from targets that are subject to the filter processing.

### Modification Example 2

In the embodiment described above, the filter processing section 23 has used a filter circuit provided at one stage to perform filter processing, as illustrated in FIG. 6. However, the present disclosure is not limited to the embodiment. Instead of the action described in the embodiment, filter circuits provided at a plurality of stages may be used to perform filter processing, for example. The modification example will now be described herein with reference to some examples.

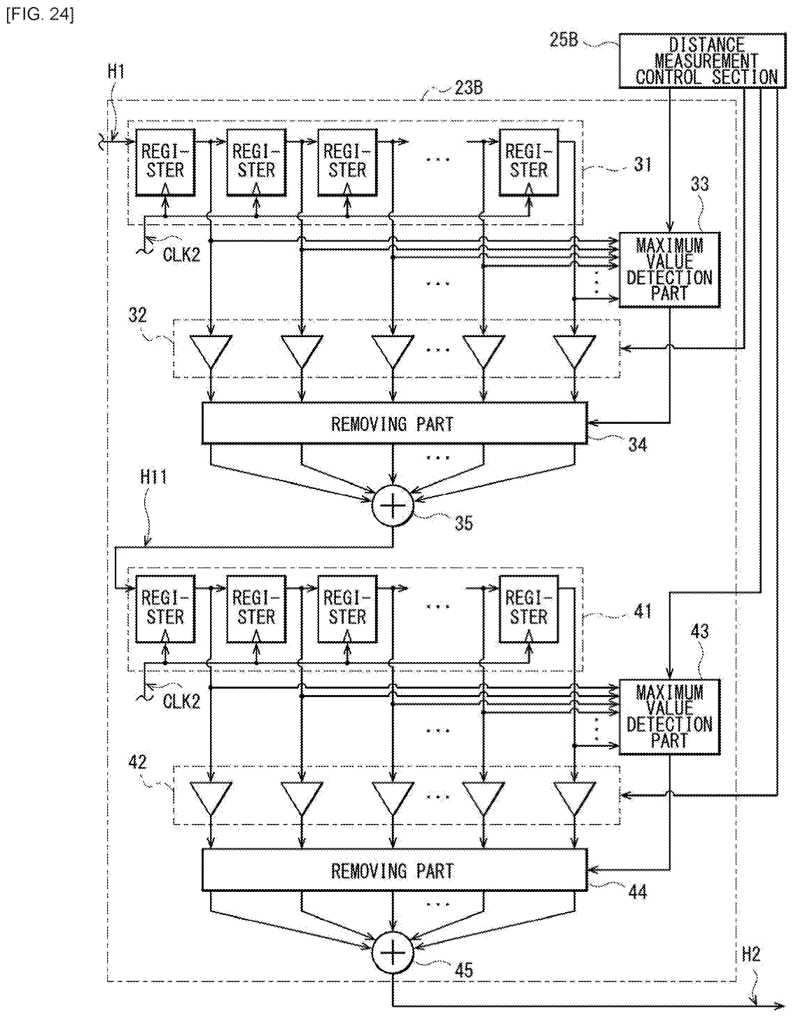

FIG. 24 illustrates a configuration example of a filter processing section 23B according to the modification example. The filter processing section 23B performs processing on the basis of an instruction from a distance measurement control section 25B. The filter processing section 23B includes the shift register 31, the multiplying part 32, the maximum value detection part 33, the removing part 34, the adding part 35, a shift register 41, a multiplying part 42, a maximum value detection part 43, a removing part 44, and an adding part 45. The shift register 31, the multiplying part 32, the maximum value detection part 33, the removing part 34, and the adding part 35 form a filter circuit at a first stage. The shift register 41, the multiplying part 42, the maximum value detection part 43, the removing part 44, and the adding part 45 form a filter circuit at a second stage. A configuration of the filter circuit at the second stage is similar to a configuration of the filter circuit at the first stage. The filter circuit at the first stage generates an intermediate histogram H11 on the basis of a histogram H1. The filter circuit at the second stage generates a histogram H2 on the basis of the intermediate histogram H11.

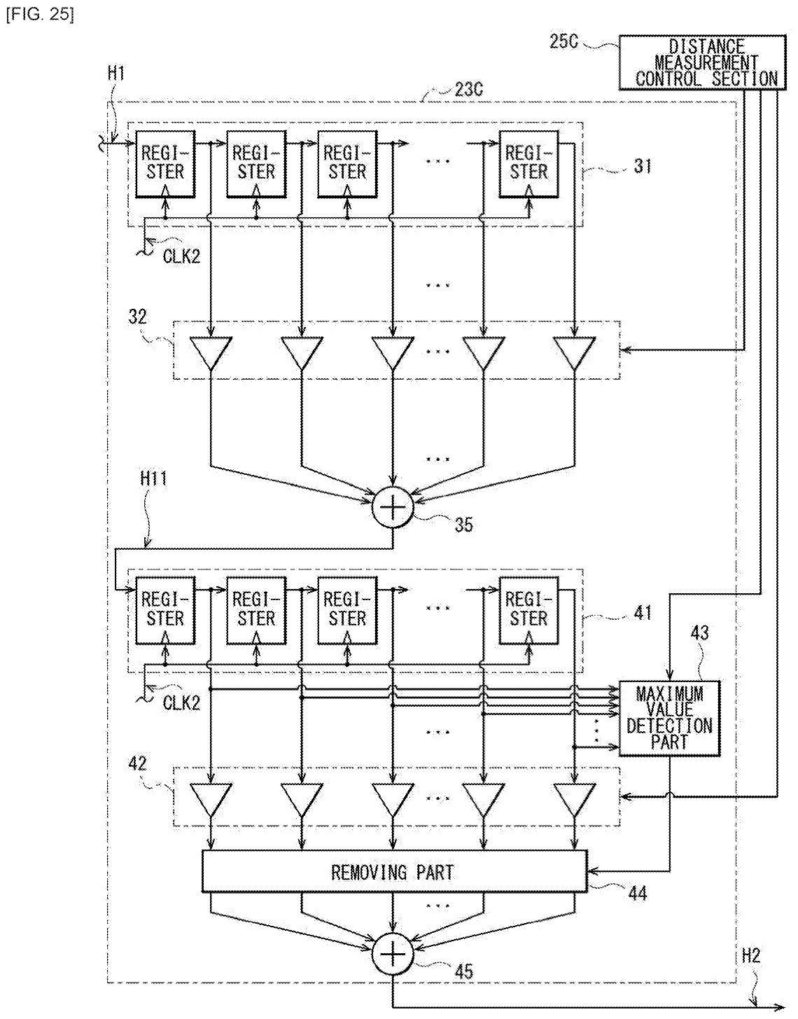

FIG. 25 illustrates a configuration example of another filter processing section 23C according to the modification example. The filter processing section 23C performs processing on the basis of an instruction from a distance measurement control section 25C. The filter processing section 23C includes the shift register 31, the multiplying part 32, the adding part 35, the shift register 41, the multiplying part 42, the maximum value detection part 43, the removing part 44, and the adding part 45. The shift register 31, the multiplying part 32, and the adding part 35 form a filter circuit at a first stage. The shift register 41, the multiplying part 42, the maximum value detection part 43, the removing part 44, and the adding part 45 form a filter circuit at a second stage. In this example, the filter circuit at the first stage uses the filter coefficient pattern as illustrated in (A) in FIG. 8 to perform histogram filter processing. Furthermore, the filter circuit at the second stage uses the filter coefficient pattern illustrated in (B) in FIG. 8 to perform decoding filter processing and to detect a maximum value.

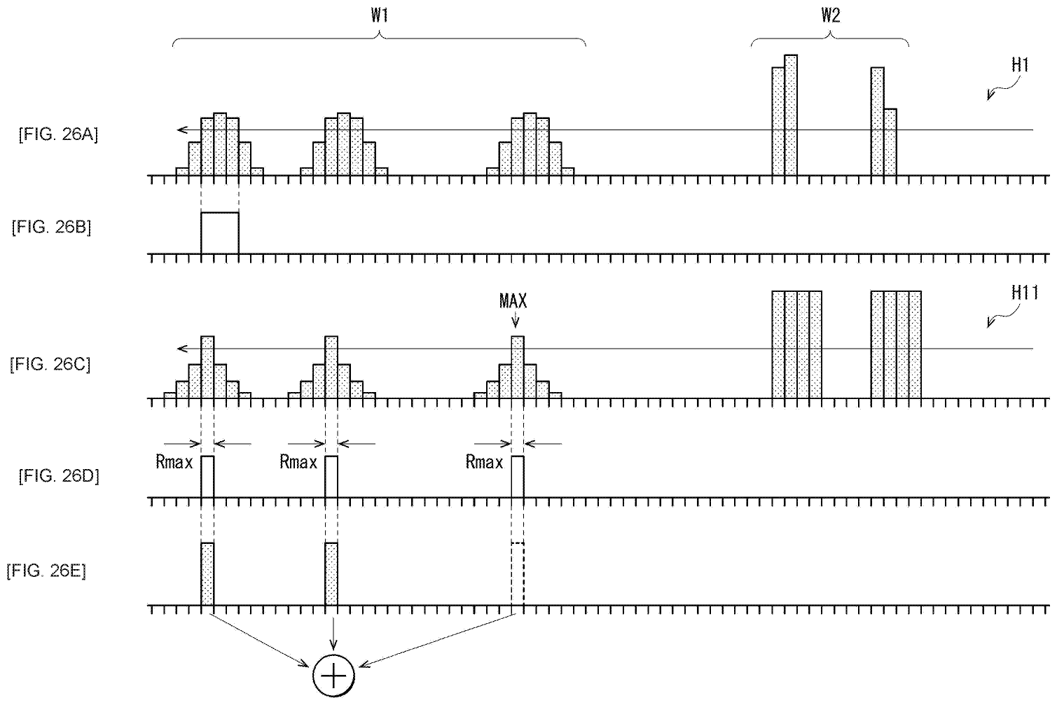

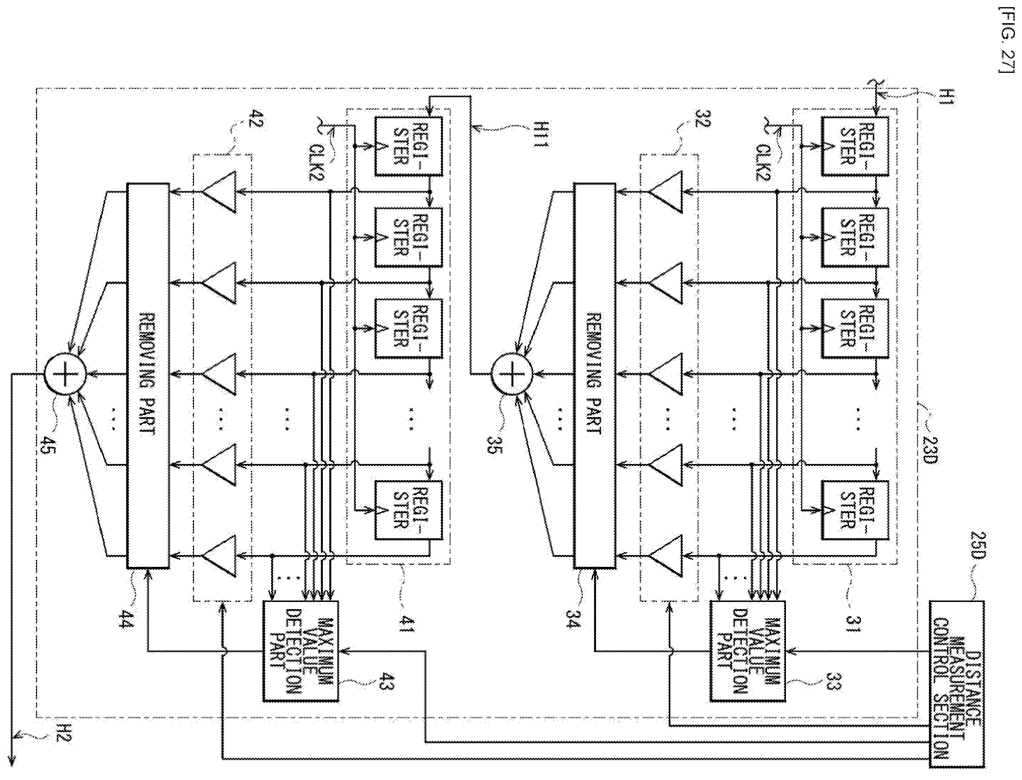

FIG. 26 illustrates an operation example of the filter processing section 23C, where (A) indicates a histogram H1, (B) indicates a filter coefficient pattern in the filter circuit at the first stage, (C) indicates an intermediate histogram H11 generated by a first filter circuit, (D) indicates a filter coefficient pattern in the filter circuit at the second stage, and (E) indicates a result of multiplying a frequency value (a count value) in the intermediate histogram H11 by a filter coefficient of the filter coefficient pattern in a second filter circuit. In the filter circuit at the second stage, similar to Operation Example E1 (FIGS. 15 and 16A to 16E), a plurality of output values where the filter coefficient is “1” among a plurality of output values outputted from the shift register 41 is set as processing targets Rmax for detecting a maximum value.

In the filter circuit at the first stage, as indicated by an arrow, the histogram H1 moves from a right side of the filter coefficient pattern toward left one by one on a scale ((A) and (B) in FIG. 26). The filter circuit at the first stage uses the filter coefficient pattern illustrated in (B) in FIG. 26 to perform histogram filter processing to generate an intermediate histogram H11 ((C) in FIG. 26).

In the filter circuit at the second stage, the intermediate histogram H11 moves from a right side of the filter coefficient pattern toward left one by one on a scale, as indicated by an arrow ((C) and (D) in FIG. 26). In this example, a portion W1 in the intermediate histogram H11 is overlapping with a region where the filter coefficient is “1” in the filter coefficient pattern. The maximum value detection part 43 in the filter circuit at the second stage detects a maximum value among three frequency values serving as the processing targets Rmax for detecting a maximum value in the histogram H11. In this example, a peak value in one of three ranges of distribution in the portion W1, which lies at a rightmost position, represents a maximum value MAX. The removing part 44 then replaces, on the basis of an instruction from the maximum value detection part 43, a value corresponding to the maximum value MAX with “0”, and outputs the replaced value ((E) in FIG. 26). The adding part 35 then adds the three values outputted from the removing part 34 to each other. The filter circuit at the second stage uses the filter coefficient pattern illustrated in (D) in FIG. 26 to perform decoding filter processing to generate a histogram H2.

FIG. 27 illustrates a configuration example of another filter processing section 23D according to the modification example. The filter processing section 23D performs processing on the basis of an instruction from a distance measurement control section 25D. The filter processing section 23D includes the shift register 31, the multiplying part 32, the maximum value detection part 33, the removing part 34, the adding part 35, the shift register 41, the multiplying part 42, the maximum value detection part 43, the removing part 44, and the adding part 45. The shift register 31, the multiplying part 32, the maximum value detection part 33, the removing part 34, and the adding part 35 form a filter circuit at a first stage. The shift register 41, the multiplying part 42, the maximum value detection part 43, the removing part 44, and the adding part 45 form a filter circuit at a second stage. In this example, the filter circuit at the first stage uses a one-shot filter coefficient pattern to perform processing and to detect a maximum value. Furthermore, the filter circuit at the second stage uses the filter coefficient pattern illustrated in FIG. 7 to perform filter processing and to detect a maximum value.

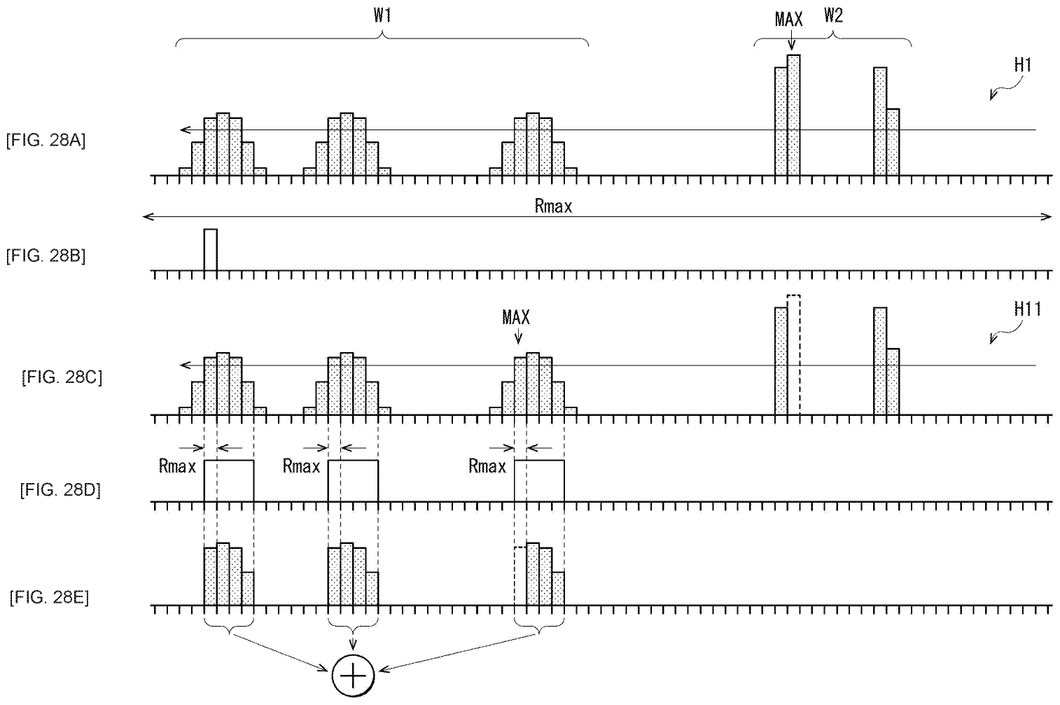

FIG. 28 illustrates an operation example of the filter processing section 23D, where (A) indicates a histogram H1, (B) indicates a filter coefficient pattern in the filter circuit at the first stage, (C) indicates an intermediate histogram H11 generated by the first filter circuit, (D) indicates a filter coefficient pattern in the filter circuit at the second stage, and (E) indicates a result of multiplying a frequency value (a count value) in the intermediate histogram H11 by a filter coefficient of the filter coefficient pattern in the second filter circuit. In the filter circuit at the first stage, similar to Operation Example E3 (FIGS. 20 and 21), all of a plurality of output values outputted from the shift register 31 are set as processing targets Rmax for detecting a maximum value. Furthermore, in the filter circuit at the second stage, similar to Operation Example E2 (FIGS. 18 and 19), one output value in each of three portions where the filter coefficient is “1” among a plurality of output values outputted from the shift register 41 is set as a processing target Rmax for detecting a maximum value.

In the filter circuit at the first stage, as indicated by arrows, the histogram H1 moves from a right side of the filter coefficient pattern toward left one by one on a scale ((A) and (B) in FIG. 28). The filter circuit at the first stage uses the one-shot filter coefficient pattern illustrated in (B) in FIG. 28 to perform processing to generate an intermediate histogram H11. The maximum value detection part 33 in the filter circuit at the first stage detects a maximum value among a plurality of frequency values serving as processing targets Rmax for detecting a maximum value in the histogram H11. In this example, a value in the portion W2 represents a maximum value MAX. Therefore, the filter circuit at the first stage replaces the value corresponding to the maximum value MAX in the histogram H1 with “0” to generate an intermediate histogram H11 ((C) in FIG. 28).

In the filter circuit at the second stage, the intermediate histogram H11 moves from a right side of the filter coefficient pattern toward left one by one on a scale, as indicated by an arrow ((C) and (D) in FIG. 28). In this example, a portion W1 in the intermediate histogram H11 is overlapping with regions where the filter coefficient is “1” in the filter coefficient pattern. The maximum value detection part 43 in the filter circuit at the second stage detects a maximum value among three frequency values serving as the processing targets Rmax for detecting a maximum value in the histogram H11. In this example, a value in one of three ranges of distribution in the portion W1, which lies at a rightmost position, represents a maximum value MAX. The removing part 44 then replaces, on the basis of an instruction from the maximum value detection part 43, the maximum value MAX with “0”, and outputs the replaced value ((E) in FIG. 28). The adding part 35 then adds the three values outputted from the removing part 34 to each other. The filter circuit at the second stage uses the filter coefficient pattern illustrated in (D) in FIG. 26 to perform de-filter processing to generate a histogram H2.

### Modification Example 3

In the embodiment described above, the filter processing section 23 has excluded a maximum value detected by the maximum value detection part 33 from targets that are subject to the filter processing. However, the present disclosure is not limited to the embodiment. For example, not only a maximum value, but also a second largest value and a third largest value, for example, may be excluded from targets that are subject to the filter processing. An example where a maximum value and a second largest value are excluded from targets that are subject to the filter processing will now be described herein in detail.

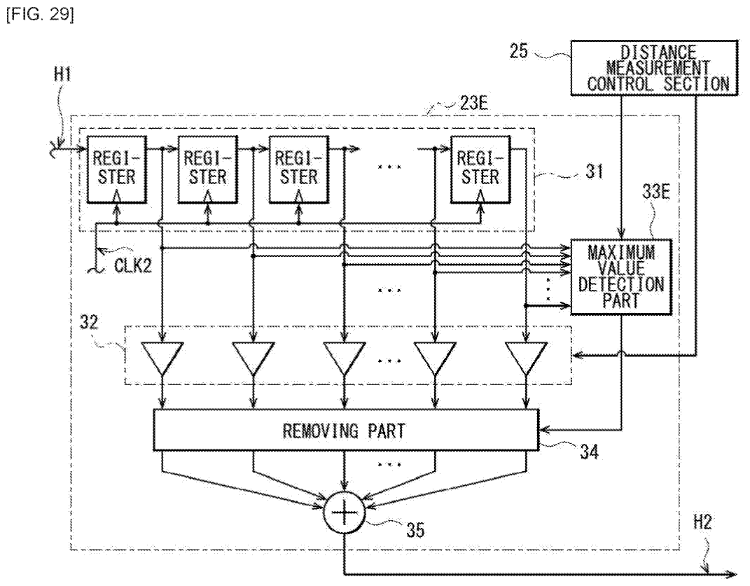

FIG. 29 illustrates a configuration example of a filter processing section 23E according to the modification example. The filter processing section 23E includes a detection part 33E. The detection part 33E is configured to detect a maximum value and a second largest value among two or more output values serving as processing targets Rmax, which are set by the distance measurement control section 25. The detection part 33E then provides, to the removing part 34, an instruction of removing a value corresponding to the maximum value and a value corresponding to the second largest value among a plurality of values outputted by the multiplying part 32.

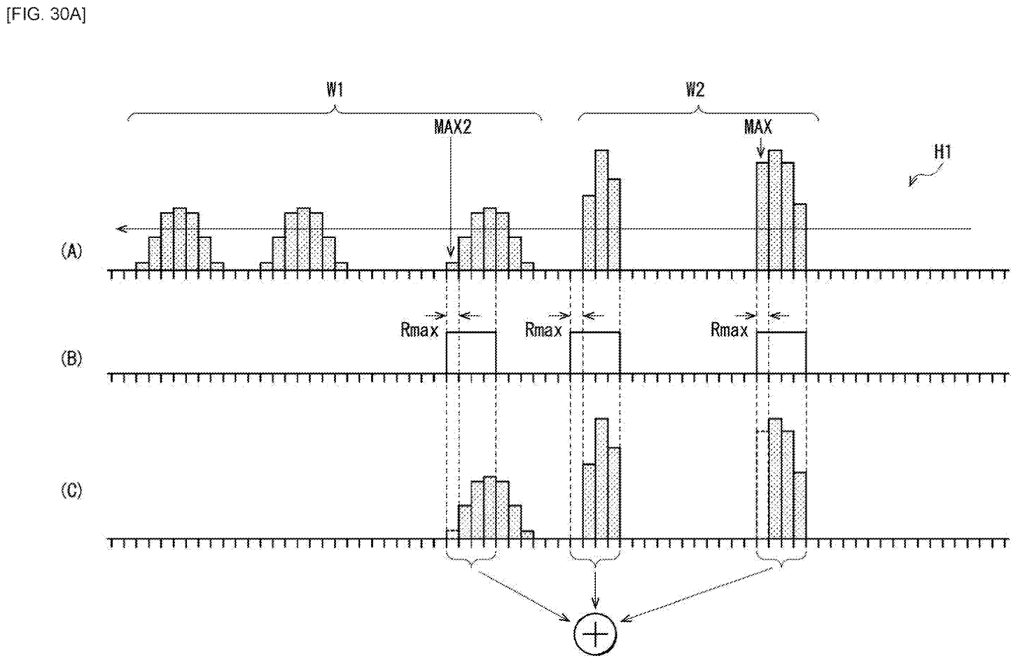

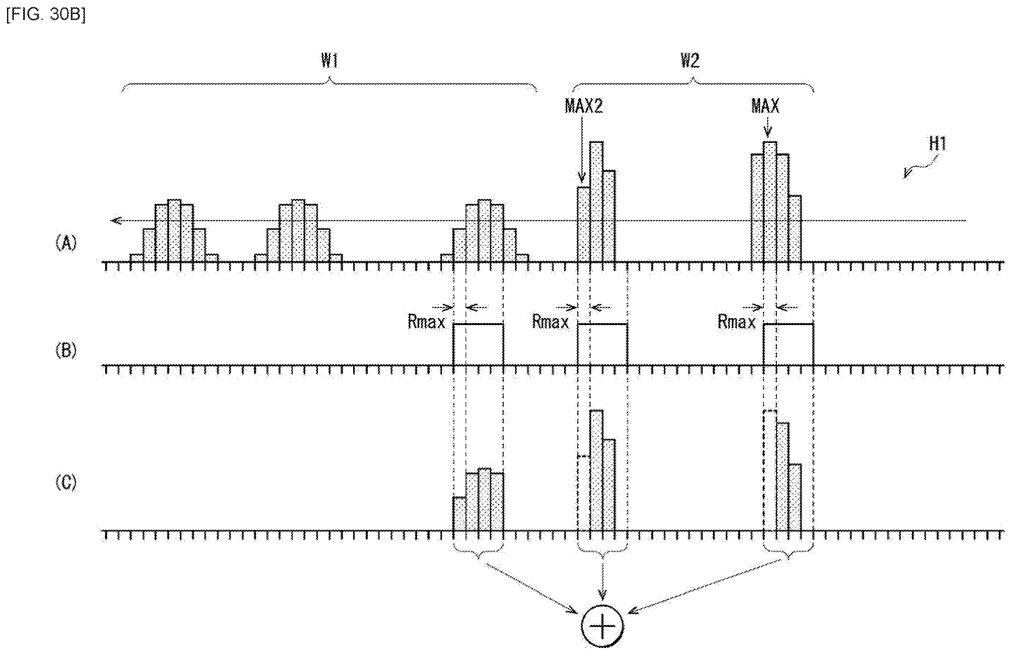

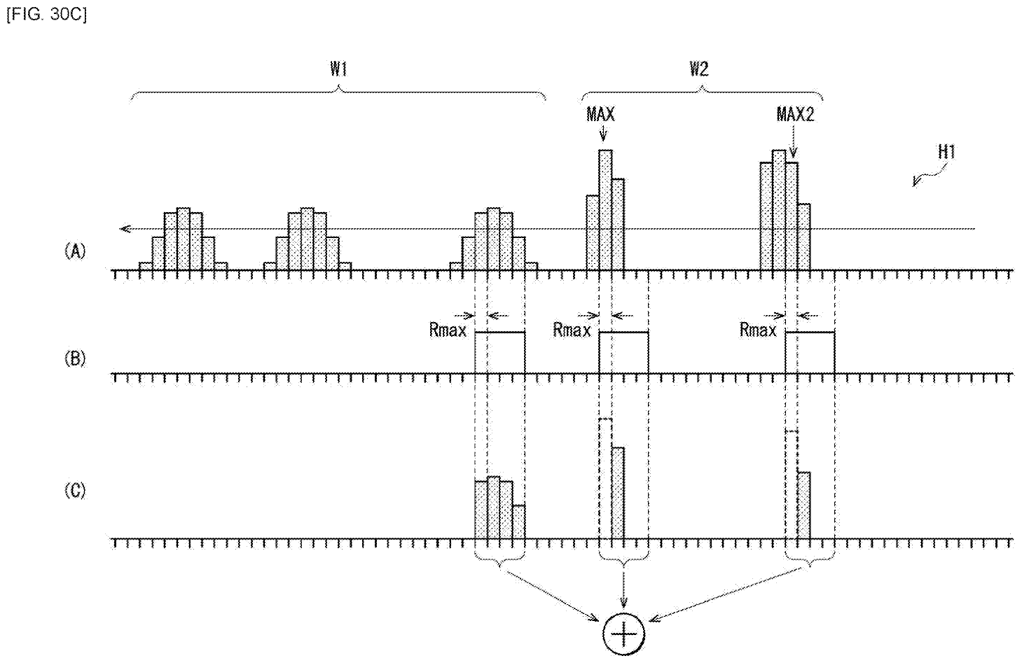

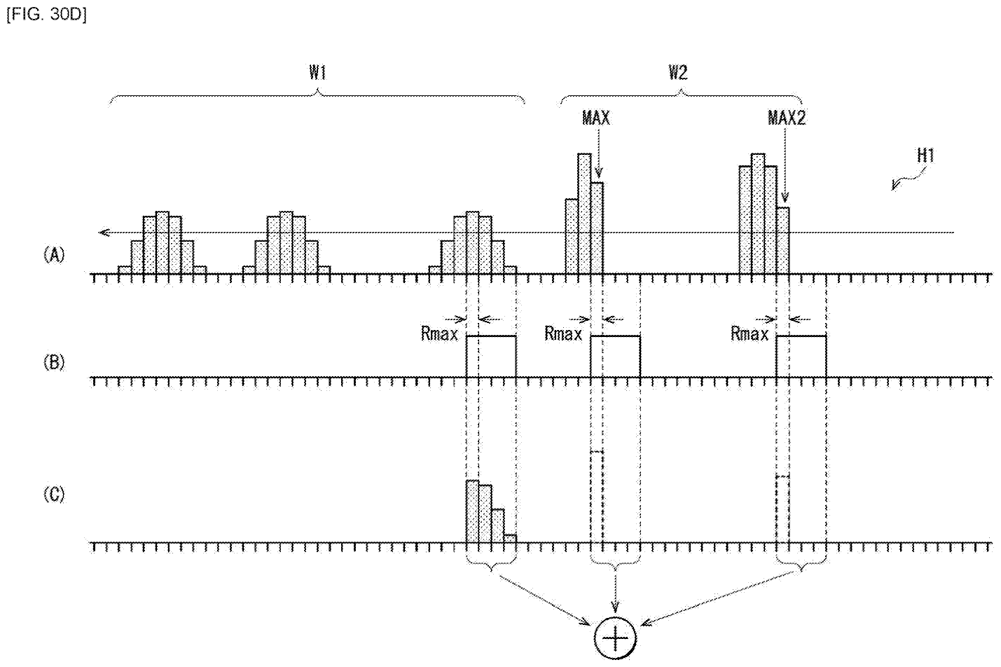

FIGS. 30A to 30D illustrate an operation example of the filter processing section 23E. In each of FIGS. 30A to 30D, (A) indicates a histogram H1, (B) indicates a filter coefficient pattern, and (C) indicates a result of multiplying a frequency value (a count value) in the histogram H1 by a filter coefficient of the filter coefficient pattern. In this example, similar to Operation Example E2 (FIGS. 18 and 19), one output value in each of three portions where the filter coefficient is “1” among a plurality of output values outputted from the shift register 31 is set as a processing target Rmax for detecting a maximum value.

In FIGS. 30A to 30D, a portion W2 in the histogram H1 is overlapping with regions where the filter coefficient is “1” in the filter coefficient pattern. As indicated by an arrow, the histogram H1 moves from a right side of the filter coefficient pattern toward left one by one on a scale.

In FIG. 30A, one of seven frequency values in the portion W2 represents a maximum value MAX, and one of a plurality of frequency values in a portion W1 represents a second largest value MAX2. In each of FIGS. 30B to 30E, one of the seven frequency values in a portion W2 represents a maximum value MAX, and another one of the seven frequency values represents a second largest value MAX2. The removing part 34 replaces, on the basis of an instruction from the detection part 33E, a value corresponding to the maximum value MAX and a value corresponding to the second largest value MAX2 with “0”, and outputs the replaced values ((C) in FIG. 30A, (C) in FIG. 30B, (C) in FIG. 30C, and (C) in FIG. 30D). The adding part 35 then adds the 12 values outputted from the removing part 34 to each other.

### Modification Example 4

In the embodiment described above, the filter processing section 23 has excluded a maximum value detected by the maximum value detection part 33 from targets that are subject to the filter processing. In that time, however, a maximum value may be excluded from targets that are subject to the filter processing in a case where a predetermined determination condition is satisfied, for example. A filter processing section 23F according to the modification example will now be described herein in detail.

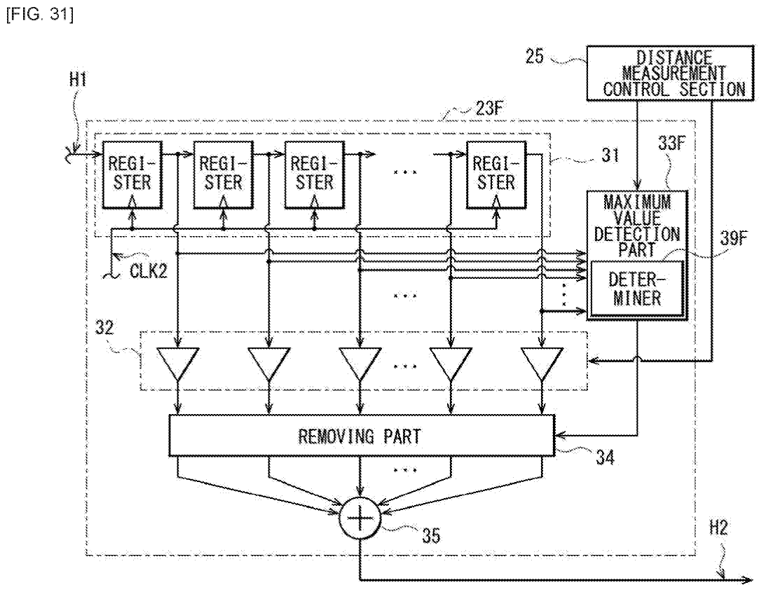

FIG. 31 illustrates a configuration example of the filter processing section 23F. The filter processing section 23F includes a maximum value detection part 33F. The maximum value detection part 33F is configured to detect, on the basis of an instruction from the distance measurement control section 25, a maximum value among two or more output values among a plurality of output values outputted from the shift register 31. The maximum value detection part 33F includes a determiner 39F. The determiner 39F is configured to determine if a detected maximum value satisfies a predetermined determination condition. In a case where the detected maximum value satisfies the predetermined determination condition, the maximum value detection part 33F provides, to the removing part 34, an instruction of removing a value corresponding to the maximum value among a plurality of values outputted by the multiplying part 32.

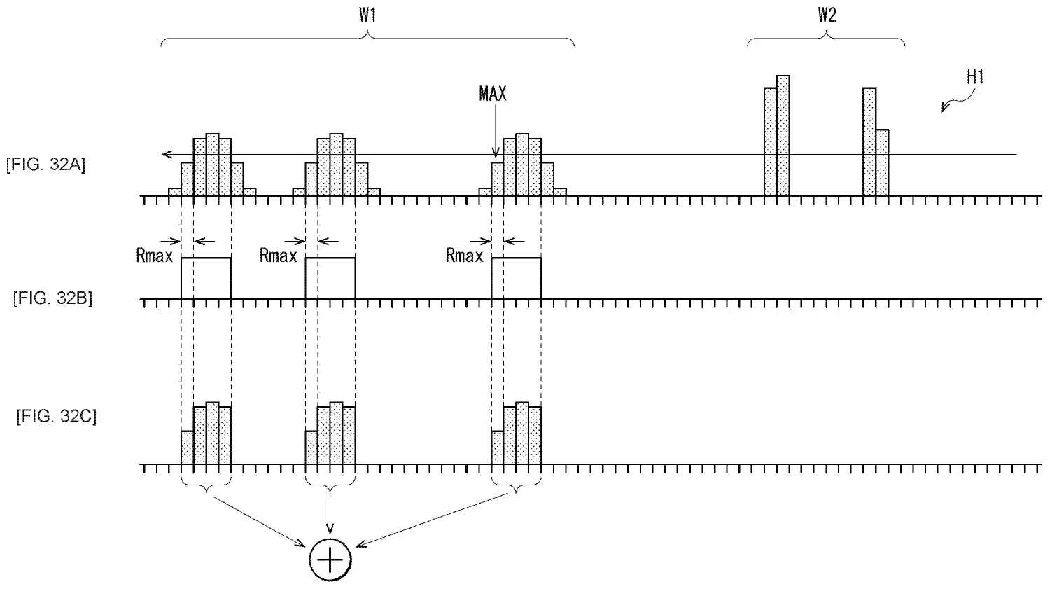

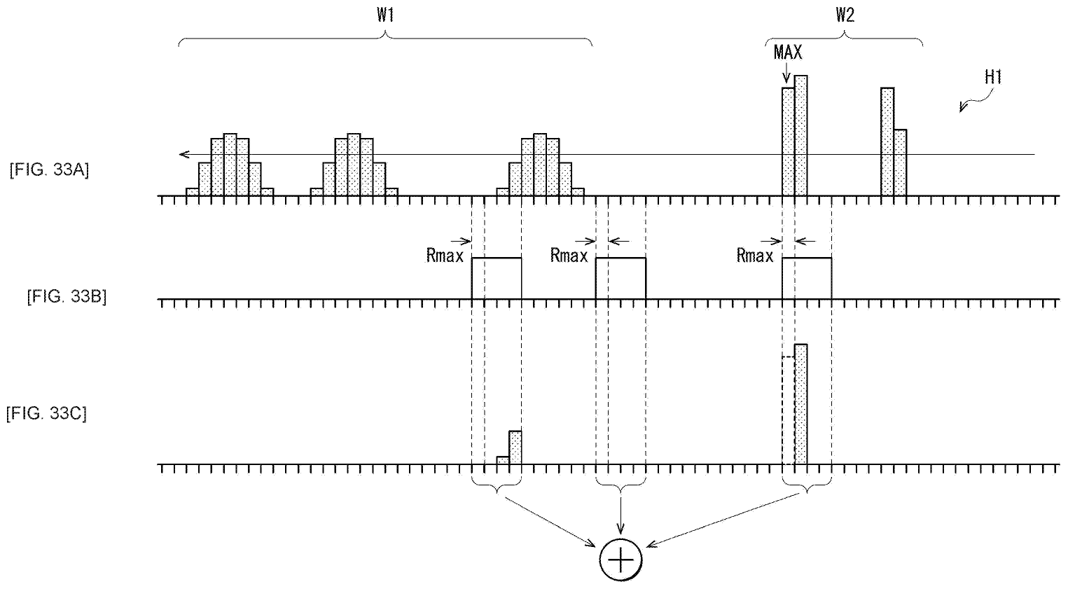

FIGS. 32 and 33 illustrate an operation example of the filter processing section 23F. In each of FIGS. 32 and 22, (A) indicates a histogram H1, (B) indicates a filter coefficient pattern, and (C) indicates a result of multiplying a frequency value (a count value) in the histogram H1 by a filter coefficient of the filter coefficient pattern. In this example, similar to Operation Example E2 (FIGS. 18 and 19), one output value in each of three portions where the filter coefficient is “1” among a plurality of output values outputted from the shift register 31 is set as a processing target Rmax for detecting a maximum value.

In FIG. 32, a portion W1 in the histogram H1 is overlapping with regions where the filter coefficient is “1” in the filter coefficient pattern ((A) and (B) in FIG. 32). The maximum value detection part 33 detects a maximum value among three frequency values serving as processing targets Rmax for detecting a maximum value in the histogram H1. In this example, a value in one of three ranges of distribution in the portion W1, which lies at a rightmost position, represents a maximum value MAX. The determiner 39F determines if the detected maximum value satisfies the predetermined determination condition. The determination condition may be a fact that, in a case where, from a maximum value among three frequency values serving as processing targets Rmax for detecting a maximum value, an average value of the three frequency values is subtracted, and a value acquired as a result of the subtraction is greater than a predetermined threshold value. In this example, the three frequency values are substantially identical to each other, and the determination condition is not satisfied. Therefore, the removing part 34 does not replace a value corresponding to the maximum value MAX with “0”, but outputs the value as is ((C) in FIG. 32). The adding part 35 then adds the 12 values outputted from the removing part 34 to each other.

In FIG. 33, a portion W2 in the histogram H1 is overlapping with a region where the filter coefficient is “1” in the filter coefficient pattern ((A) and (B) in FIG. 33). The maximum value detection part 33 detects a maximum value among the three frequency values serving as the processing targets Rmax for detecting a maximum value in the histogram H1. In this example, one of four frequency values in the portion W2 represents a maximum value MAX. In this example, the maximum value MAX is fully greater, compared with the other two values, satisfying the determination condition. Therefore, the maximum value detection part 33F provides, to the removing part 34, an instruction of removing a value corresponding to the maximum value MAX among a plurality of values outputted by the multiplying part 32. The removing part 34 replaces, on the basis of an instruction from the maximum value detection part 33F, the value corresponding to the maximum value MAX among the plurality of values outputted by the multiplying part 32 with “0”, and outputs the replaced value ((C) in FIG. 33). The adding part 35 then adds the 12 values outputted from the removing part 34 to each other.

### Modification Example 5

In the embodiment described above, lengths of a plurality of photodetection periods T have been set to be identical to each other. However, the present disclosure is not limited to the embodiment. For example, each of the photodetection periods T may be changed. The modification example will now be described herein in detail.

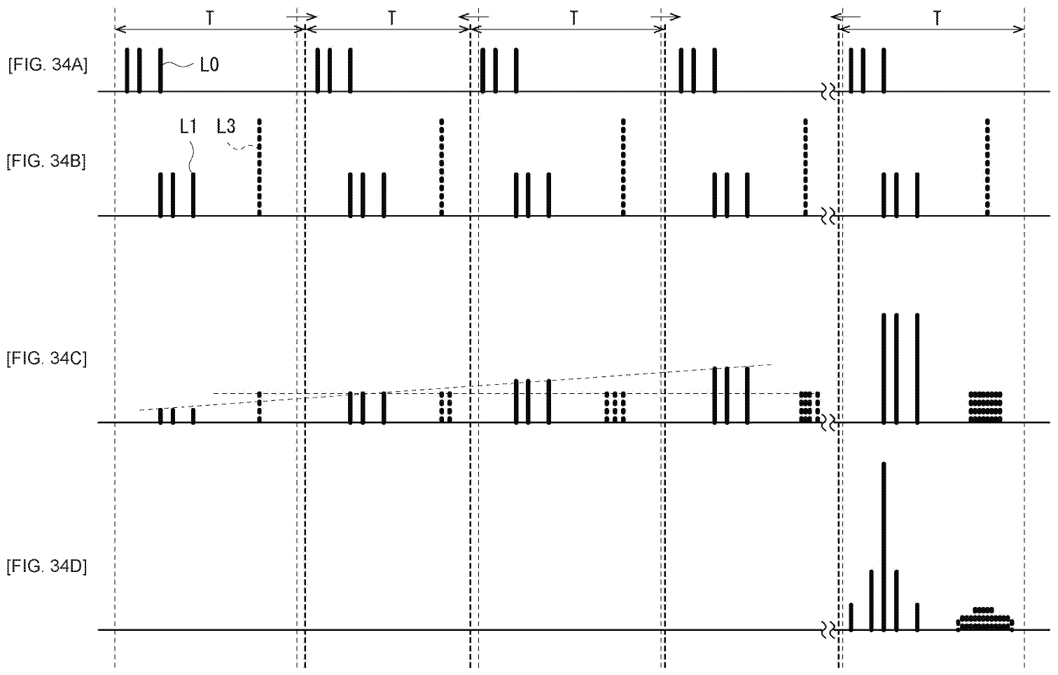

FIG. 34 illustrates an operation example of a photodetection system according to the modification example, where (A) indicates a waveform of light emitted by the light-emitting section 12, (B) indicates a waveform of incident light into the light-receiving section P, (C) indicates distribution of count values CNT1 to CNT100 of the histogram generation section 22, and (D) indicates a histogram H2.

The light-emitting section 12 emits three light pulses L0 on the basis of a start timing of each of a plurality of photodetection periods T ((A) in FIG. 34). The light-receiving section P detects three reflected light pulses L1 at a timing that is delayed by a time in accordance with a distance between the photodetection system 1 and a measurement target, on the basis of the start timing of each of the plurality of photodetection periods T ((B) in FIG. 34). Therefore, timings at which the light-receiving section P detects reflected light pulses L1 are identical to each other in each of the plurality of photodetection periods T. As a result, each time three reflected light pulses L1 are detected, a plurality of count values corresponding to the three reflected light pulses L1 among count values CNT1 to CNT100 gradually increases ((C) in FIG. 34). On the other hand, since interference light L3 occurs at a constant cycle, a timing at which the light-receiving section P detects the interference light L3 changes in each of the plurality of photodetection periods T. Therefore, a plurality of count values corresponding to the interference light L3 among the count values CNT1 to CNT100 does not so increase. As a result, as illustrated in (D) in FIG. 34, a histogram H2 has a peak that is high at a portion based on reflected light pulses L1.

FIG. 34 has illustrated that a plurality of count values corresponding to the interference light L3 among the count values CNT1 to CNT100 does not so increase. However, the plurality of count values may increase depending on a situation. Even in such a case, a maximum value detected by the maximum value detection part 33 is excluded from targets that are subject to the filter processing, making it possible to prevent distance measuring accuracy from lowering, similar to the case described in the embodiment described above.

### Modification Example 6

In the embodiment described above, a histogram H1 about detection timings of reflected light pulses L1 in each of the light-receiving sections P has been generated on the basis of a detection signal Sdet. However, a maximum value among count values may be detected in each of a plurality of photodetection periods T in that time, and the detected maximum value may not be cumulatively added, for example. A histogram generation section 22G according to the modification example will now be described herein in detail.

FIG. 35 illustrates a configuration example of the histogram generation section 22G according to the modification example. The histogram generation section 22G includes a maximum value detection part 53G. The maximum value detection part 53G is configured to detect a maximum value among count values acquired by the accumulators AC1 to AC100 in each of a plurality of photodetection periods T. The maximum value detection part 53G then provides, to the accumulator that has generated the count value corresponding to the maximum value, an instruction of not cumulatively adding the maximum value.

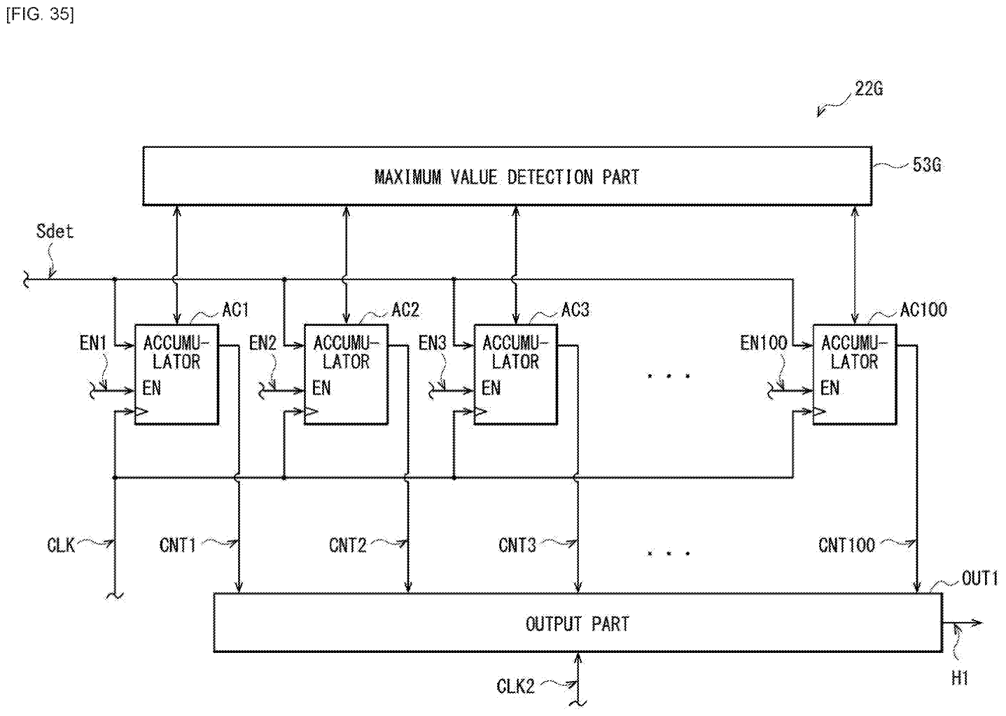

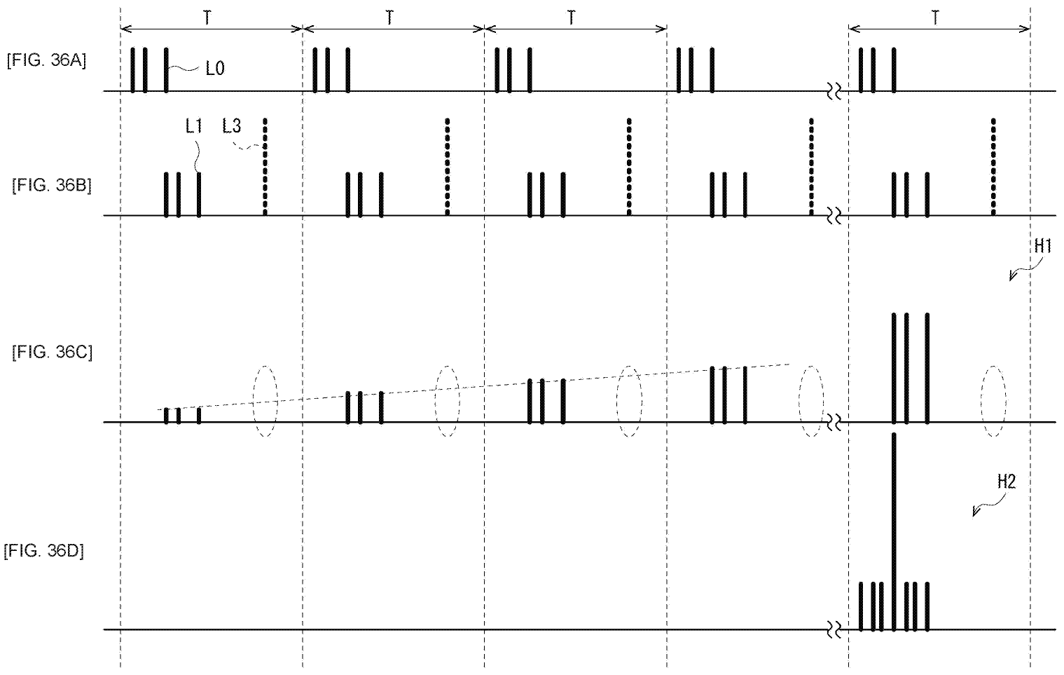

FIG. 36 illustrates an operation example of a photodetection system according to the modification example, where (A) indicates a waveform of light emitted by the light-emitting section 12, (B) indicates a waveform of incident light into the light-receiving section P, (C) indicates distribution of count values CNT1 to CNT100 of the histogram generation section 22G, and (D) indicates a histogram H2.

The light-receiving section P detects, in each of a plurality of photodetection periods T, three reflected light pulses L1 in accordance with three light pulses L0 that the light-emitting section 12 has emitted and interference light L3 ((A) and (B) in FIG. 36). The 100 accumulators AC1 to AC100 in the histogram generation section 22G respectively generate count values CNT1 to CNT100 on the basis of a detection signal Sdet that the light-receiving section P has generated ((C) in FIG. 36). The maximum value detection part 53G in the histogram generation section 22G detects a maximum value among count values acquired by the accumulators AC1 to AC100 in each of the plurality of photodetection periods T. In this example, a count value in accordance with the interference light L3 may represent a maximum value, in each of the plurality of photodetection periods T. The maximum value detection part 53G provides, to the accumulator that has generated the count value representing the maximum value, an instruction of not cumulatively adding the maximum value. Thereby, no count value in accordance with the interference light L3 occurs, as illustrated by circles each plotted with a dotted line in (C) in FIG. 36. As a result, as illustrated in (D) in FIG. 36, a histogram H2 has a peak that is high at a portion based on reflected light pulses L1.

In this example, the histogram generation section 22G has detected a maximum value among count values acquired by the accumulators AC1 to AC100 in each of a plurality of photodetection periods T. However, the present disclosure is not limited to the example. A maximum value and a second largest value may be detected, similar to the detection part 33E according to Modification Example 3, for example. Furthermore, in a case where a detected maximum value satisfies a predetermined determination condition, the maximum value may not be cumulatively added, similar to the maximum value detection part 33F according to Modification Example 4, for example.

### Other Modification Examples

Furthermore, two or more of the modification examples described above may be combined with each other.

### 2. Example of Application to Mobile Body

The technology (the present technology) according to the present disclosure is applicable to a variety of products. For example, the technology according to the present disclosure may be achieved as an apparatus to be installed aboard any type of mobile body such as an automobile, an electric vehicle, a hybrid electric vehicle, a motorcycle, a bicycle, a personal mobility, an airplane, a drone, a vessel, or a robot.

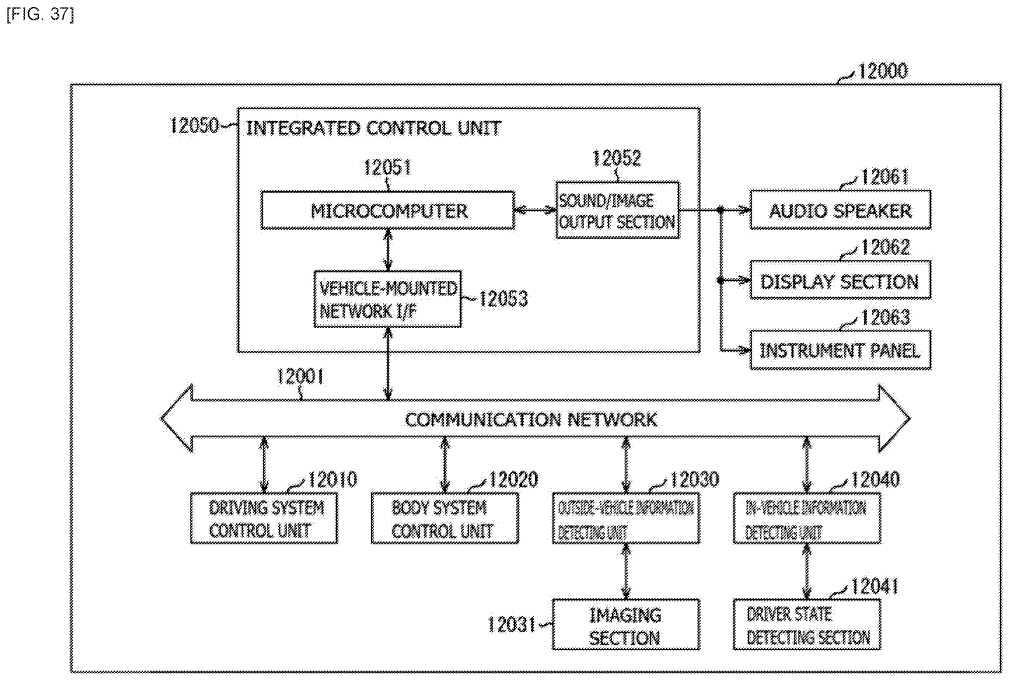

FIG. 37 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 37, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 37, an audio speaker 12061, a display section 12062, and an instrument panel 12063 are illustrated as the output device. The display section 12062 may, for example, include at least one of an on-board display and a head-up display.

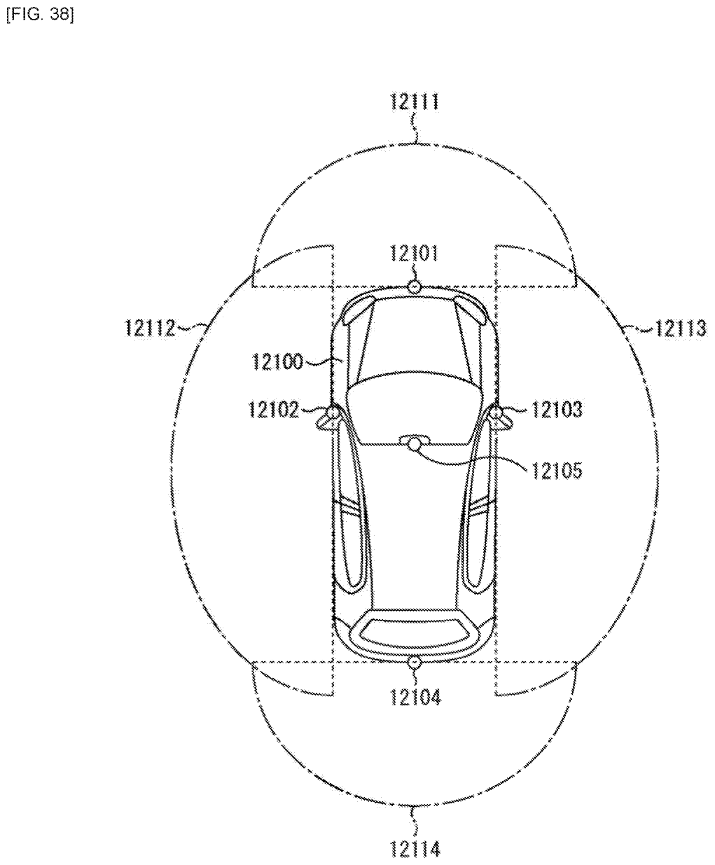

FIG. 38 is a diagram depicting an example of the installation position of the imaging section 12031.

In FIG. 38, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 38 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-described components. This makes it possible, in the vehicle control system 12000, to prevent distance measuring accuracy from lowering even in a case where there is interference light. As a result, it is possible for the vehicle control system 12000 to achieve, with high accuracy, a collision avoidance or collision mitigation function for the vehicle, a following driving function based on vehicle-to-vehicle distance, a vehicle speed maintaining driving function, a warning function against collision of the vehicle, a warning function against deviation of the vehicle from a lane, and the like.

Although the present technology has been described above with reference to the embodiment, the modification examples, and the specific application example thereof, the present technology is not limited to the embodiment and the like, and may be modified in a wide variety of ways.

In the embodiment and others described above, for example, the pulse interval P2 differs in a plurality of pulse patterns, as illustrated in FIG. 2. However, the present disclosure is not limited to the embodiment and others. Instead of the embodiment and others, the pulse width P1 may differ in a plurality of pulse patterns, for example, and the number of light pulses L0 may differ, for example.

In the embodiment and others described above, for example, a plurality of light pulses L0 respectively having pulse patterns identical to each other in a plurality of photodetection periods T has been emitted to perform a distance measurement. However, the pulse patterns may be changed per each of the plurality of photodetection periods T as a unit, for example. In this case, the filter processing section 23 uses a filter coefficient pattern in accordance with the changed pulse pattern to perform filter processing.

Note that the effects described in the present specification are merely exemplary and non-limiting, and other effects may also be achieved.

It is to be noted that the present technology may have the following configurations. According to the technique having the configurations described below, it is possible to prevent distance measuring accuracy from lowering even in a case where there is interference light.

(1)

A photodetector including:
a light-receiving element configured to detect a plurality of light pulses having a predetermined pulse pattern;
a histogram generation circuit configured to generate a first histogram on a basis of detection timings in the light-receiving element;
a filter circuit configured to generate a second histogram on a basis of the first histogram by performing filter processing using a filter coefficient pattern corresponding to the pulse pattern; and
a representative value calculation circuit configured to calculate a representative value of the detection timings on a basis of the second histogram, in which
the filter circuit is configured to exclude, from targets of the filter processing, a first frequency value being a maximum value among a first plurality of frequency values in the first histogram or a processing-target histogram being an intermediate histogram corresponding to the first histogram.
   (2)

The photodetector according to (1), in which
the filter processing includes respectively multiplying a second plurality of frequency values in the processing-target histogram by a plurality of filter coefficients included in the filter coefficient pattern, and performing an addition of a result of the multiplication, and
the first plurality of frequency values includes a portion of a plurality of frequency values corresponding to the filter coefficient pattern among the second plurality of frequency values.
   (3)

The photodetector according to (1), in which
the filter processing includes respectively multiplying a second plurality of frequency values in the processing-target histogram by a plurality of filter coefficients included in the filter coefficient pattern, and performing an addition of a result of the multiplication, and
the first plurality of frequency values includes the second plurality of frequency values.
   (4)

The photodetector according to any one of (1) to (3), further including a setting circuit that sets the first plurality of frequency values being detection targets for the maximum value.

(5)

The photodetector according to any one of (1) to (4), in which
the filter circuit includes a first filter circuit and a second filter circuit,
the first filter circuit is configured to generate the intermediate histogram by performing first filter processing on a basis of the first histogram,
the second filter circuit is configured to generate the second histogram by performing second filter processing on a basis of the intermediate histogram,
the processing-target histogram includes the intermediate histogram, and
the second filter circuit is configured to exclude the first frequency value from targets of the second filter processing.
   (6)

The photodetector according to any one of (1) to (5), in which the filter circuit is configured to exclude the first frequency value from the targets of the filter processing in a case where the first plurality of frequency values satisfies a predetermined determination condition.

(7)

The photodetector according to (6), in which the predetermined determination condition includes a condition indicating a relationship between the first frequency value and one or more frequency values other than the first frequency value among the first plurality of frequency values.

(8)

The photodetector according to any one of (1) to (7), in which the filter circuit is further configured to exclude, from the targets of the filter processing, a second frequency value being a second largest value among the first plurality of frequency values in the processing-target histogram.

(9)

The photodetector according to any one of (1) to (8), in which
the light-receiving element is configured to detect the plurality of light pulses in each of a plurality of photodetection periods to be repeatedly set, and
respective time lengths of the plurality of detection periods are equal to each other.
   (10)

The photodetector according to any one of (1) to (8), in which
the light-receiving element is configured to detect the plurality of light pulses in each of a plurality of photodetection periods to be repeatedly set, and
the plurality of photodetection periods includes a first photodetection period of a first time length and a second photodetection period of a second time length.
   (11)

The photodetector according to any one of (1) to (10), including:
a plurality of the light-receiving elements; and
an adder circuit, in which
each of the plurality of the light-receiving elements is configured to generate a pulse signal corresponding to a result of a detection,
the adder circuit is configured to generate a detection signal corresponding to the number of pulses on a basis of the pulse signal generated by each of the plurality of the light-receiving elements, and
the histogram generation circuit is configured to generate the first histogram on a basis of the detection signal.
   (12)

The photodetector according to (11), in which
each of the plurality of the light-receiving elements is configured to detect the plurality of light pulses in each of the plurality of photodetection periods to be repeatedly set, and
the histogram generation circuit is configured to generate the first histogram by cumulatively add each of a third plurality of frequency values in each of the plurality of photodetection periods, and
the histogram generation circuit is configured not to cumulatively add a third frequency value being a maximum value among the third plurality of frequency values in each of the plurality of photodetection periods.
   (13)

A photodetection system including:
a light-emitting section configured to emit a first plurality of light pulses having a predetermined pulse pattern;
a light-receiving element configured to detect a second plurality of light pulses corresponding to the first plurality of light pulses;
a histogram generation circuit configured to generate a first histogram on a basis of detection timings in the light-receiving element;
a filter circuit configured to generate a second histogram on a basis of the first histogram by performing filter processing using a filter coefficient pattern corresponding to the pulse pattern; and
a representative value calculation circuit configured to calculate a representative value of the detection timings on a basis of the second histogram, in which
the filter circuit is configured to exclude, from targets of the filter processing, a first frequency value being a maximum value among a first plurality of frequency values in the first histogram or a processing-target histogram being an intermediate histogram corresponding to the first histogram.
   (14)

A photodetection method including:
emitting a first plurality of light pulses having a predetermined pulse pattern;
detecting a second plurality of light pulses corresponding to the first plurality of light pulses;
generating a first histogram on a basis of detection timings of the second plurality of light pulses;
generating a second histogram, on a basis of the first histogram, by performing filter processing using a filter coefficient pattern corresponding to the pulse pattern;
excluding, from targets of the filter processing, a first frequency value being a maximum value among a first plurality of frequency values in the first histogram or a processing-target histogram being an intermediate histogram corresponding to the first histogram; and
calculating a representative value of the detection timings on a basis of the second histogram.

The present application claims the benefit of Japanese Priority Patent Application JP2021-093715 filed with the Japan Patent Office on Jun. 3, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A photodetector comprising:
a light-receiving element configured to detect a plurality of light pulses having a predetermined pulse pattern;
a histogram generation circuit configured to generate a first histogram on a basis of detection timings in the light-receiving element;
a filter circuit configured to generate a second histogram on a basis of the first histogram by performing filter processing using a filter coefficient pattern corresponding to the pulse pattern; and
a representative value calculation circuit configured to calculate a representative value of the detection timings on a basis of the second histogram, wherein
the filter circuit is configured to exclude, from targets of the filter processing, a first frequency value being a maximum value among a first plurality of frequency values in the first histogram or a processing-target histogram being an intermediate histogram corresponding to the first histogram.

2. The photodetector according to claim 1, wherein
the filter processing includes respectively multiplying a second plurality of frequency values in the processing-target histogram by a plurality of filter coefficients included in the filter coefficient pattern, and performing an addition of a result of the multiplication, and
the first plurality of frequency values comprises a portion of a plurality of frequency values corresponding to the filter coefficient pattern among the second plurality of frequency values.

3. The photodetector according to claim 1, wherein
the filter processing includes respectively multiplying a second plurality of frequency values in the processing-target histogram by a plurality of filter coefficients included in the filter coefficient pattern, and performing an addition of a result of the multiplication, and
the first plurality of frequency values comprises the second plurality of frequency values.

4. The photodetector according to claim 1, further comprising a setting circuit that sets the first plurality of frequency values being detection targets for the maximum value.

5. The photodetector according to claim 1, wherein
the filter circuit includes a first filter circuit and a second filter circuit,
the first filter circuit is configured to generate the intermediate histogram by performing first filter processing on a basis of the first histogram,
the second filter circuit is configured to generate the second histogram by performing second filter processing on a basis of the intermediate histogram,
the processing-target histogram comprises the intermediate histogram, and
the second filter circuit is configured to exclude the first frequency value from targets of the second filter processing.

6. The photodetector according to claim 1, wherein the filter circuit is configured to exclude the first frequency value from the targets of the filter processing in a case where the first plurality of frequency values satisfies a predetermined determination condition.

7. The photodetector according to claim 6, wherein the predetermined determination condition comprises a condition indicating a relationship between the first frequency value and one or more frequency values other than the first frequency value among the first plurality of frequency values.

8. The photodetector according to claim 1, wherein the filter circuit is further configured to exclude, from the targets of the filter processing, a second frequency value being a second largest value among the first plurality of frequency values in the processing-target histogram.

9. The photodetector according to claim 1, wherein
the light-receiving element is configured to detect the plurality of light pulses in each of a plurality of photodetection periods to be repeatedly set, and
respective time lengths of the plurality of detection periods are equal to each other.

10. The photodetector according to claim 1, wherein
the light-receiving element is configured to detect the plurality of light pulses in each of a plurality of photodetection periods to be repeatedly set, and
the plurality of photodetection periods includes a first photodetection period of a first time length and a second photodetection period of a second time length.

11. The photodetector according to claim 1, comprising:
a plurality of the light-receiving elements; and
an adder circuit, wherein
each of the plurality of the light-receiving elements is configured to generate a pulse signal corresponding to a result of a detection,
the adder circuit is configured to generate a detection signal corresponding to the number of pulses on a basis of the pulse signal generated by each of the plurality of the light-receiving elements, and
the histogram generation circuit is configured to generate the first histogram on a basis of the detection signal.

12. The photodetector according to claim 11, wherein
each of the plurality of the light-receiving elements is configured to detect the plurality of light pulses in each of a plurality of photodetection periods to be repeatedly set, and
the histogram generation circuit is configured to generate the first histogram by cumulatively add each of a third plurality of frequency values in each of the plurality of photodetection periods, and
the histogram generation circuit is configured not to cumulatively add a third frequency value being a maximum value among the third plurality of frequency values in each of the plurality of photodetection periods.

13. A photodetection system comprising:
a light-emitting section configured to emit a first plurality of light pulses having a predetermined pulse pattern;
a light-receiving element configured to detect a second plurality of light pulses corresponding to the first plurality of light pulses;
a histogram generation circuit configured to generate a first histogram on a basis of detection timings in the light-receiving element;
a filter circuit configured to generate a second histogram on a basis of the first histogram by performing filter processing using a filter coefficient pattern corresponding to the pulse pattern; and
a representative value calculation circuit configured to calculate a representative value of the detection timings on a basis of the second histogram, wherein
the filter circuit is configured to exclude, from targets of the filter processing, a first frequency value being a maximum value among a first plurality of frequency values in the first histogram or a processing-target histogram being an intermediate histogram corresponding to the first histogram.

14. A photodetection method comprising:
emitting a first plurality of light pulses having a predetermined pulse pattern;
detecting a second plurality of light pulses corresponding to the first plurality of light pulses;
generating a first histogram on a basis of detection timings of the second plurality of light pulses;
generating a second histogram, on a basis of the first histogram, by performing filter processing using a filter coefficient pattern corresponding to the pulse pattern;
excluding, from targets of the filter processing, a first frequency value being a maximum value among a first plurality of frequency values in the first histogram or a processing-target histogram being an intermediate histogram corresponding to the first histogram; and
calculating a representative value of the detection timings on a basis of the second histogram.
